(19) United States
(12) Patent Application Publication
(10) Pub. No.: US 2025/0317815 A1
(43) Pub. Date: Oct. 9, 2025

(54) SIGNALING FOR SYSTEM INFORMATION BLOCKS

(71) Applicant: QUALCOMM Incorporated, San Diego, CA (US)

(72) Inventors: Xiao Feng WANG, San Diego, CA (US); Alberto RICO ALVARINO, San Diego, CA (US); Peter GAAL, San Diego, CA (US); Le LIU, San Jose, CA (US); Jae Ho RYU, San Diego, CA (US); Bharat SHRESTHA, San Diego, CA (US); Umesh PHUYAL, San Diego, CA (US); Liangping MA, San Diego, CA (US)

(21) Appl. No.: 19/089,992

(22) Filed: Mar. 25, 2025

Related U.S. Application Data
(60) Provisional application No. 63/574,146, filed on Apr. 3, 2024.

(51) Int. Cl. H04W 36/00; H04L 5/00; H04W 36/08

(52) U.S. Cl. CPC H04W 36/0072; H04L 5/0053; H04W 36/0061; H04W 36/08

(57) ABSTRACT

Some wireless communications systems include terrestrial network (TN) nodes or non-terrestrial network (NTN) nodes (e.g., satellites) for communicating with user equipments (UEs). Support for power sharing among beams and reducing the overhead of the downlink channels (e.g., a synchronization signal block (SSB) or one or more system information blocks (SIBs)) may be sought to increase a quantity of supported beams. To enhance SIB reception, a UE may monitor for a plurality of control resource sets (CORESETs) that includes a first CORESET and at least one repetition of the first CORESET in some approaches. The repetition of the first CORESET may be located relative to the first CORESET. The UE may communicate a message (e.g., SIB) with the network entity using the repetition of the first CORESET. Some approaches may support slot aggregation for a PDSCH(s) carrying SIBs or limiting monitoring occasions based on an SSB.

### CROSS REFERENCE

The present Application for Patent claims the benefit of U.S. Provisional Patent Application No. 63/574,146 by WANG et al., entitled “SIGNALING FOR SYSTEM INFORMATION BLOCKS,” filed Apr. 3, 2024, assigned to the assignee hereof, and expressly incorporated by reference herein.

### FIELD OF TECHNOLOGY

The following relates to wireless communications, including signaling for system information blocks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

Some wireless communications systems include non-terrestrial network (NTN) nodes (e.g., satellites) for communicating with user equipments (UEs) located on or near the Earth's surface. Due to limited power and a limited quantity of radio frequency (RF) chains, a relatively small portion (e.g., 5%, 10%, 20%, or 30%, among other examples) of the satellite beams may be utilized for transmission at a time. Support for power sharing among beams and reducing the overhead of the downlink channels (e.g., a synchronization signal block (SSB), a system information block 1 (SIB1), or other system information blocks (SIBs) (e.g., system information block 19 (SIB19)) may be sought to increase a quantity of supported beams under the constraints of limited power and RF chains. To enhance SIB reception, a UE may monitor a search space in a monitoring occasion for a plurality of control resource sets (CORESETs) that includes a first CORESET and at least one repetition of the first CORESET. The UE may receive, from a network entity (e.g., an NTN node or satellite, among other examples), the repetition of the first CORESET in the monitoring occasion via second resource elements (REs) that are located in a time and a frequency that are defined relative to first REs associated with the first CORESET. The repetition of the first CORESET may include a control message scheduling transmission of a message (e.g., a PDSCH or SIB1). For example, a CORESET may include information (e.g., a PDCCH, downlink control information (DCI), or other information) to schedule a SIB (e.g., SIB1, SIB19). The UE may communicate the message with the network entity using the information indicated by the control message included in the repetition of the first CORESET.

A method for wireless communications by a UE is described. The method may include monitoring a search space in a monitoring occasion for a set of multiple CORESETs, the set of multiple CORESETs including a first CORESET and a second CORESET, receiving, from a network entity, the second CORESET in the monitoring occasion via second REs that are located in a time and a frequency that are defined relative to first REs associated with the first CORESET, the second CORESET including a control message scheduling transmission of a message, and communicating the message with the network entity using information indicated by the control message included in the second CORESET.

A UE for wireless communications is described. The UE may include one or more memories storing processor executable code, and one or more processors coupled with the one or more memories. The one or more processors may individually or collectively be operable to execute the code to cause the UE to monitor a search space in a monitoring occasion for a set of multiple CORESETs, the set of multiple CORESETs including a first CORESET and a second CORESET, receive, from a network entity, the second CORESET in the monitoring occasion via second REs that are located in a time and a frequency that are defined relative to first REs associated with the first CORESET, the second CORESET including a control message scheduling transmission of a message, and communicate the message with the network entity using information indicated by the control message included in the second CORESET.

Another UE for wireless communications is described. The UE may include means for monitoring a search space in a monitoring occasion for a set of multiple CORESETs, the set of multiple CORESETs including a first CORESET and a second CORESET, means for receiving, from a network entity, the second CORESET in the monitoring occasion via second REs that are located in a time and a frequency that are defined relative to first REs associated with the first CORESET, the second CORESET including a control message scheduling transmission of a message, and means for communicating the message with the network entity using information indicated by the control message included in the second CORESET.

A non-transitory computer-readable medium storing code for wireless communications is described. The code may include instructions executable by one or more processors to monitor a search space in a monitoring occasion for a set of multiple CORESETs, the set of multiple CORESETs including a first CORESET and a second CORESET, receive, from a network entity, the second CORESET in the monitoring occasion via second REs that are located in a time and a frequency that are defined relative to first REs associated with the first CORESET, the second CORESET including a control message scheduling transmission of a message, and communicate the message with the network entity using information indicated by the control message included in the second CORESET.

In some examples of the method, UEs, and non-transitory computer-readable medium described herein, the message includes a SIB1 in a physical downlink shared channel (PDSCH) that may be scheduled based on the set of multiple CORESETs, and the SIB1 indicates a repetition of a CORESET that may be specific to a type of one or more search spaces.

Some examples of the method, UEs, and non-transitory computer-readable medium described herein may further include operations, features, means, or instructions for receiving the repetition of the CORESET based on the SIB1.

Some examples of the method, UEs, and non-transitory computer-readable medium described herein may further include operations, features, means, or instructions for detecting a failure to decode the first CORESET via the first REs associated with the first CORESET and monitoring, during the monitoring occasion, for the second CORESET via the second REs based on an assumption that CORESET repetition may be activated in response to the failure to decode the first CORESET.

In some examples of the method, UEs, and non-transitory computer-readable medium described herein, the monitoring for the second CORESET uses blind decoding without a previous indication that CORESET repetition may be activated.

Some examples of the method, UEs, and non-transitory computer-readable medium described herein may further include operations, features, means, or instructions for decoding a physical downlink control channel (PDCCH) using a combination of the first CORESET and the second CORESET.

In some examples of the method, UEs, and non-transitory computer-readable medium described herein, the second CORESET may be indicated by cyclic redundancy check (CRC) masking, demodulation reference signal (DMRS) scrambling, or encoded DCI bit scrambling.

In some examples of the method, UEs, and non-transitory computer-readable medium described herein, the second CORESET may be indicated by a quantity of the first REs associated with the first CORESET that satisfies a first threshold, by a bandwidth or quantity of REs associated with the first CORESET that satisfies a second threshold, or by communication of the first CORESET in a specific frequency band.

Some examples of the method, UEs, and non-transitory computer-readable medium described herein may further include operations, features, means, or instructions for receiving a handover command for a target cell indicating that CORESET repetition may be activated and receiving neighbor cell information associated with a neighbor cell of the target cell, the neighbor cell information indicating CORESET repetition information for the neighbor cell.

In some examples of the method, UEs, and non-transitory computer-readable medium described herein, one or more bits of a PDCCH associated with the first CORESET may be fixed or removed for a format of the PDCCH that may be scrambled by a system information radio network temporary identifier (SI-RNTI) in a specific frequency band.

In some examples of the method, UEs, and non-transitory computer-readable medium described herein, DCI associated with the first CORESET indicates a quantity of slots for aggregation of an PDSCH that carries an SIB.

In some examples of the method, UEs, and non-transitory computer-readable medium described herein, the PDSCH may be scheduled via a common search space (CSS).

Some examples of the method, UEs, and non-transitory computer-readable medium described herein may further include operations, features, means, or instructions for receiving a synchronization signal block (SSB), where the search space may be monitored based on the monitoring occasion occurring within a threshold period after the SSB.

A method for wireless communications by a network entity is described. The method may include transmitting, in a search space during a monitoring occasion, a set of multiple CORESETs, the set of multiple CORESETs including a first CORESET and a second CORESET, where the second CORESET is transmitted via second REs that are located in a time and a frequency that are defined relative to first REs associated with the first CORESET, the second CORESET including a control message scheduling transmission of a message and communicating the message with a UE using information indicated by the control message included in the second CORESET.

A network entity for wireless communications is described. The network entity may include one or more memories storing processor executable code, and one or more processors coupled with the one or more memories. The one or more processors may individually or collectively be operable to execute the code to cause the network entity to transmit, in a search space during a monitoring occasion, a set of multiple CORESETs, the set of multiple CORESETs including a first CORESET and a second CORESET, where the second CORESET is transmitted via second REs that are located in a time and a frequency that are defined relative to first REs associated with the first CORESET, the second CORESET including a control message scheduling transmission of a message and communicate the message with a UE using information indicated by the control message included in the second CORESET.

Another network entity for wireless communications is described. The network entity may include means for transmitting, in a search space during a monitoring occasion, a set of multiple CORESETs, the set of multiple CORESETs including a first CORESET and a second CORESET, where the second CORESET is transmitted via second REs that are located in a time and a frequency that are defined relative to first REs associated with the first CORESET, the second CORESET including a control message scheduling transmission of a message and means for communicating the message with a UE using information indicated by the control message included in the second CORESET.

A non-transitory computer-readable medium storing code for wireless communications is described. The code may include instructions executable by one or more processors to transmit, in a search space during a monitoring occasion, a set of multiple CORESETs, the set of multiple CORESETs including a first CORESET and a second CORESET, where the second CORESET is transmitted via second REs that are located in a time and a frequency that are defined relative to first REs associated with the first CORESET, the second CORESET including a control message scheduling transmission of a message and communicate the message with a UE using information indicated by the control message included in the second CORESET.

In some examples of the method, network entities, and non-transitory computer-readable medium described herein, the message includes a SIB1 in an PDSCH that may be scheduled based on the set of multiple CORESETs, and the SIB1 indicates a repetition of a CORESET that may be specific to a type of one or more search spaces.

Some examples of the method, network entities, and non-transitory computer-readable medium described herein may further include operations, features, means, or instructions for transmitting the repetition of the CORESET based on the SIB1.

In some examples of the method, network entities, and non-transitory computer-readable medium described herein, the second CORESET may be indicated by CRC masking, DMRS scrambling, or encoded DCI bit scrambling.

In some examples of the method, network entities, and non-transitory computer-readable medium described herein, the second CORESET may be indicated by a quantity of the first REs associated with the first CORESET that satisfies a first threshold, by a bandwidth or quantity of REs associated with the first CORESET that satisfies a second threshold, or by communication of the first CORESET in a specific frequency band.

Some examples of the method, network entities, and non-transitory computer-readable medium described herein may further include operations, features, means, or instructions for transmitting a handover command for a target cell indicating that CORESET repetition may be activated and transmitting neighbor cell information associated with a neighbor cell of the target cell, the neighbor cell information indicating CORESET repetition information for the neighbor cell.

### BRIEF DESCRIPTION OF THE DRAWINGS

FIG. 1 shows an example of a wireless communications system that supports signaling for system information blocks in accordance with one or more aspects of the present disclosure.

FIG. 2 shows an example of a network architecture that supports signaling for system information blocks in accordance with one or more aspects of the present disclosure.

FIG. 3 shows an example of a wireless communications system that supports signaling for system information blocks in accordance with one or more aspects of the present disclosure.

FIG. 4 shows an example of a timing diagram that supports signaling for system information blocks in accordance with one or more aspects of the present disclosure.

FIG. 5 shows an example of a timing diagram that supports signaling for system information blocks in accordance with one or more aspects of the present disclosure.

FIG. 6 shows an example of a process flow that supports signaling for system information blocks in accordance with one or more aspects of the present disclosure.

FIGS. 7 and 8 show block diagrams of devices that support signaling for system information blocks in accordance with one or more aspects of the present disclosure.

FIG. 9 shows a block diagram of a communications manager that supports signaling for system information blocks in accordance with one or more aspects of the present disclosure.

FIG. 10 shows a diagram of a system including a device that supports signaling for system information blocks in accordance with one or more aspects of the present disclosure.

FIGS. 11 and 12 show block diagrams of devices that support signaling for system information blocks in accordance with one or more aspects of the present disclosure.

FIG. 13 shows a block diagram of a communications manager that supports signaling for system information blocks in accordance with one or more aspects of the present disclosure.

FIG. 14 shows a diagram of a system including a device that supports signaling for system information blocks in accordance with one or more aspects of the present disclosure.

FIGS. 15 through 18 show flowcharts illustrating methods that support signaling for system information blocks in accordance with one or more aspects of the present disclosure.

### DETAILED DESCRIPTION

Some wireless communications systems include non-terrestrial network (NTN) nodes (e.g., satellites) for communicating with user equipments (UEs) located on or near the Earth's surface. In some approaches, a low-Earth orbit (LEO) satellite may support from hundreds to thousands of beams or cells. Due to limited power and a limited quantity of radio frequency (RF) chains, a relatively small portion of the satellite beams may be utilized for transmission at a time. Support for power sharing among beams and reducing the overhead of the downlink channels (e.g., a synchronization signal block (SSB), a system information block 1 (SIB1), or other system information blocks (SIBs) (e.g., system information block 19 (SIB19)) may be sought to increase a quantity of supported beams under the constraints of limited power and RF chains.

Due to the limited transmit power and channel bandwidth, a UE may attempt to receive a SIB (e.g., multiple repetitions of a SIB1) to decode a system information (SI) message. For instance, with a 5 megahertz (MHz) bandwidth, a signal-to-noise ratio (SNR) for decoding a SIB1 physical downlink shared channel (PDSCH) may be −5.8 decibels (dB) at an error rate of 10%, or an SNR for scheduling a physical downlink control channel (PDCCH) may be −5.9 dB at an error rate of 1%. A specified or target SNR may be larger for a larger SIB (e.g., a SIB19). However, the actual SNR for transmission may be as low as −9 dB. Consequently, a network entity may have to transmit a large quantity of repetitions to ensure reception by UEs, which may lead to increased delay (e.g., 2 seconds) or a relatively large amount of downlink overhead.

A UE may monitor a search space in a monitoring occasion for a plurality of control resource sets (CORESETs) that includes a first CORESET and at least one second CORESET (e.g., a repetition of the first CORESET). The UE may receive, from a network entity (e.g., an NTN node or satellite, among other examples), the repetition of the first CORESET in the monitoring occasion via second resource elements (REs) that are located in a time and a frequency (e.g., a predefined time and frequency) that are defined relative to first REs associated with the first CORESET. The repetition of the first CORESET may include a control message scheduling transmission of a message (e.g., a PDSCH or SIB1). For example, a CORESET may include information (e.g., a PDCCH) to schedule a SIB (e.g., SIB1). A PDCCH may be a physical channel (e.g., a modulated signal including encoded data bits, cyclic redundancy check (CRC), and DMRS, among other examples). In some aspects, data bits of a PDCCH may be downlink control information (DCI) bits. In some approaches, one or more PDCCHs may be included in a CORESET. The UE may communicate a message with the network entity using the information indicated by the control message included in the repetition of the first CORESET. For instance, a PDCCH may schedule a downlink transmission (e.g., PDSCH) or an uplink transmission (e.g., physical uplink shared channel (PUSCH)).

By using the first CORESET and at least one repetition of the first CORESET, the UE may more reliably receive the information in the CORESET, which may increase a probability of successfully receiving the message (e.g., PDSCH or SIB1). For instance, a message (e.g., SIB1) may be more likely to be scheduled successfully by providing more opportunities to receive the first CORESET or by enabling combined decoding of the first CORESET and the repetition(s). This may improve the probability of receiving the message via one transmission, rather than via multiple transmissions of the message. Because the first CORESET itself is repeated in the monitoring occasion, this may also reduce or avoid repeatedly receiving pairs of a PDCCH and a PDSCH to successfully receive the message. Accordingly, latency for successful reception of a message may also be reduced. In some cases, the message may include a SIB1, which may be utilized to schedule further signaling or may allow a UE to establish a link or connection. Accordingly, improving the reliability of CORESET reception via repetition of the CORESET may also improve subsequent signaling reliability or reduce latency for subsequent signaling.

Locating the repetition(s) of the CORESET in a predefined time or a predefined frequency relative to the first CORESET may reduce overhead signaling. For instance, a UE may be enabled to locate one or more repetitions of the first CORESET with the predefined time or predefined frequency relationship between the first CORESET and the repetition(s), which may avoid overhead signaling to indicate the location of the repetition(s) in time or frequency. Additionally, or alternatively, the UE may be enabled to receive an SIB1 indicating the time and frequency relative to the first CORESET.

In some approaches, a message may include a SIB1 in a PDSCH. The SIB1 may indicate a repetition of a CORESET that is specific to a type of search space. For example, the SIB1 may be utilized to indicate a repetition of a CORESET for a type of search space that may be utilized to establish or improve a link. In some aspects, the SIB1 may indicate a CORESET repetition for Type0 common search space (CSS) that may be used to schedule a SIB19, where the SIB19 may be utilized to obtain significant data relating to an NTN node, such as ephemeris, timing, or Doppler information. Utilizing the SIB1 to indicate repetition of a CORESET that is specific to a type of SIB may avoid performing repetitions for any or all CORESET types, which may avoid repetitions for other CORESET types, thereby reducing overhead signaling.

In some approaches, DCI in a CORESET may be utilized to indicate a quantity of slots for aggregation of a PDSCH that carries a SIB. The PDSCH may be scheduled by a PDCCH (e.g., DCI) via a CSS. Utilizing the DCI to indicate the quantity of slots for aggregation may allow flexibility in allocating resources for repetition of a PDSCH. Repeating the PDSCH that carries a SIB may provide an increased probability of reception of the PDSCH and the SIB. Because the SIB may be utilized to schedule further scheduling or to establish a link, allowing an indication for repetition of the PDSCH and SIB may provide increased communication reliability. Allowing the PDSCH carrying a SIB to be scheduled using a CSS may provide increased signaling flexibility, and may allow multiple UEs to receive the SIB. A SIB may include system information that is relevant to all or multiple UEs. In some examples, SIBs may be broadcasted. Accordingly, PDSCHs that carry SIBs may be scheduled by PDCCHs in a CSS.

In some approaches, a UE may receive an SSB, where search space monitoring may be based on the monitoring occasion occurring within a threshold period after the SSB. The SSB may provide information that is utilized to receive signaling (e.g., a PDCCH) in the monitoring occasion. As a period between the SSB and signaling increases, the information (e.g., timing or frequency information) of the SSB may be less relevant or accurate for receiving the signaling due to changes in the channel over time. Accordingly, keeping allowed monitoring occasions within the threshold period may increase the likelihood of receiving signaling in the monitoring occasions based on the SSB, as the information of the SSB may be more relevant or accurate.

Aspects of the disclosure are initially described in the context of wireless communications systems. Aspects of the disclosure are also described in the context of timing diagrams and a process flow diagram. Aspects of the disclosure are further illustrated by and described with reference to apparatus diagrams, system diagrams, and flowcharts that relate to signaling for system information blocks.

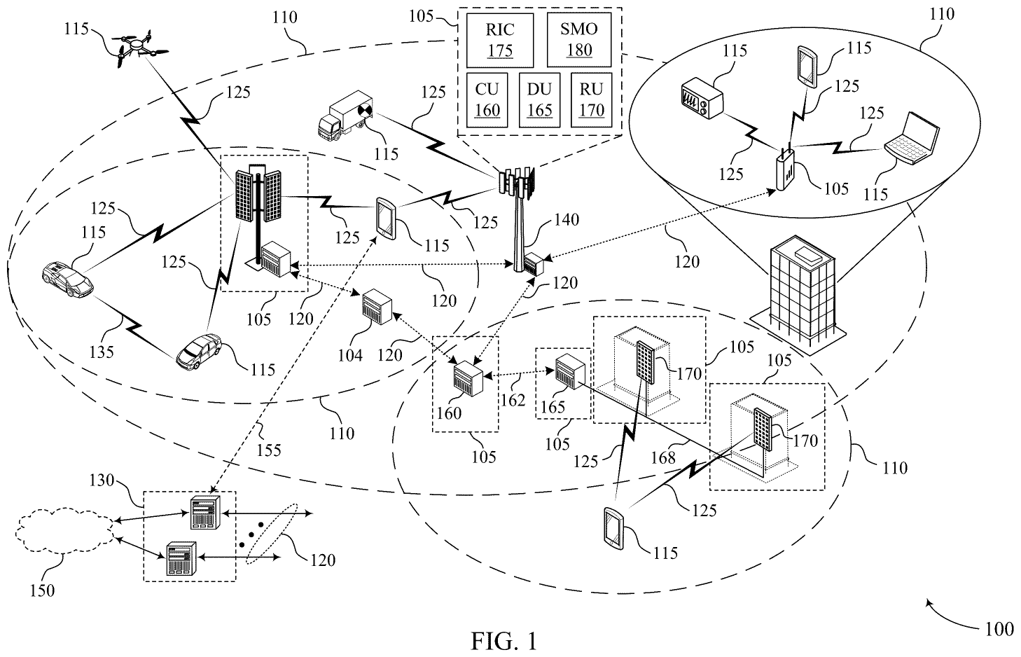

FIG. 1 shows an example of a wireless communications system 100 that supports signaling for system information blocks in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a CRC), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems include NTN nodes (e.g., satellites) for communicating with UEs 115 located on or near the Earth's surface. In some approaches, a LEO satellite may support from hundreds to thousands of beams or cells. Due to limited power and a limited quantity of RF chains, a relatively small portion of the satellite beams may be utilized for transmission at a time. Support for power sharing among beams and reducing the overhead of the downlink channels (e.g., an SSB), a SIB1, or other SIBs (e.g., SIB19) may be sought to increase a quantity of supported beams under the constraints of limited power and RF chains.

In some approaches for SIB1 and SI transmission, a SIB1 may be transmitted with a periodicity of 160 ms. Within a period, multiple SIB1 transmissions may be scheduled by PDCCHs in a Type0 CSS using CORESET0. Up to 8 SIB1 transmissions may be scheduled within a period, where the quantity of transmissions may be based on network implementation. Other SIBs may be transmitted with a configurable periodicity (e.g., a periodicity that may be larger than 160 ms). Multiple transmissions of a SIB within a period may be performed via scheduling.

In some approaches, a SIB may provide scheduling information. For instance, a SIB1 may provide scheduling information for one or more other SI messages. In some examples, an SI message may include one or more SIBs. An SI message may include an SI window length parameter. The SI window length may be same for all scheduled SI messages. A formula may be utilized to determine where the start of the SI window. In some examples, a UE 115 may search a PDCCH (e.g., a system information radio network temporary identifier (SI-RNTI)) to receive the SI message during the SI window. An SI periodicity may be configured per SI message, which may produce a gap between two SI windows. Any change in an SI message may occur after the upcoming boundary of an SI modification period (other than an SI message for an earthquake and tsunami warning system (ETWS), commercial mobile alert system (CMAS), or positioning assistance data (e.g., a SIB9 or SIB19 carrying ephemeris data)). The SI modification boundary may include multiple SI windows for repetition or retransmission. Listing (1) illustrates examples of SI window length (e.g., “si-WindowLength”), SI periodicity (e.g., “si-Periodicity”), and SIB types (e.g., “sibType2” and “sibType3,” among other examples).

```
SI-SchedulingInfo ::= SEQUENCE {
schedulingInfoList SEQUENCE (SIZE (1.maxSI-Message)) OF
SchedulingInfo,
si-WindowLength ENUMERATED {s5, s10, s20, s40, s80, s160, s320, s640,
s1280},
si-RequestConfig SI-RequestConfig OPTIONAL, -- Cond MSG-1
si-RequestConfigSUL SI-RequestConfig OPTIONAL, -- Cond SUL-
MSG-1
systemInformationAreaID BIT STRING (SIZE (24)) OPTIONAL, --
Need R
..
}
SchedulingInfo ::= SEQUENCE {
si-BroadcastStatus ENUMERATED {broadcasting, notBroadcasting},
si-Periodicity ENUMERATED {rf8, rf16, rf32, rf64, rf128, rf256, rf512},
sib-MappingInfo SIB-Mapping
}
SIB-Mapping ::=  SEQUENCE (SIZE (1.maxSIB)) OF SIB-TypeInfo
SIB-TypeInfo ::=  SEQUENCE {
type ENUMERATED {sibType2, sibType3, sibType4, sibType5, sibType6,
sibType7, sibType8, sibType9,
      sibType10-v1610, sibType11-v1610, sibType12-v1610,
sibType13-v1610, sibType14-v1610,
      spare3, spare2, spare1,.. },
valueTag INTEGER (0.31) OPTIONAL, -- Cond SIB-TYPE
areaScope ENUMERATED {true} OPTIONAL -- Need S
}
                          Listing (1)
```

Due to limited transmit power and channel bandwidth, a UE 115 may attempt to receive a SIB (e.g., multiple repetitions of a SIB1) to decode an SI message. For instance, with a 5 MHz bandwidth, an SNR for decoding a SIB1 PDSCH may be −5.8 dB at an error rate of 10%, or an SNR for scheduling a PDCCH may be −5.9 dB at an error rate of 1%. The SNR may be larger for a relatively large-sized SIB19. However, the actual SNR for transmission may be as low as −9 dB. Consequently, a network entity may have to transmit a large quantity of repetitions to ensure reception by UEs 115, which may lead to increased delay or a relatively large amount of downlink overhead.

To help ensure coverage or reduce the overhead, enhancements for SIB transmissions are described. Some of the techniques described herein may improve coverage for each one-shot SIB transmission. In some examples, CORESETs repetition or extension may be utilized. For instance, a CORESET of a monitoring occasion may be repeated N times. The frequency and time location of the CORESET repetitions may be specified relative to an initial CORESET. For a potential PDCCH, the same quantity of REs may be utilized in the repeated CORESET(s) as in the initial CORESET. In some approaches, to allow a UE 115 to differentiate whether repetition is applied, CRC masking (e.g., another radio network temporary identifier (RNTI)), another demodulation reference signal (DMRS) scrambling sequence, or another DCI scrambling may be applied to indicate CORESET repetition. In some examples, slot aggregation may be supported for a PDSCH carrying SIBs. In some approaches, PDCCH monitoring occasions may be limited for the SIB1 or SIB19 to be within a threshold time from a transmitted SSB.

A UE 115 may monitor a search space in a monitoring occasion for a plurality of CORESETs that includes a first CORESET and a second CORESET (e.g., at least one repetition of the first CORESET). In some examples, the second CORESET may have a same candidate index and/or aggregation level as the first CORESET. The UE 115 may receive, from a network entity (e.g., an NTN node or satellite, among other examples), the repetition of the first CORESET in the monitoring occasion via second REs that are located in a time and a frequency that are defined (e.g., predefined) relative to first REs associated with the first CORESET. The repetition of the first CORESET may include a control message scheduling transmission of a message (e.g., a PDSCH or SIB1). For example, a CORESET may include information (e.g., a PDCCH) to schedule a SIB (e.g., SIB1). The UE 115 may communicate with the network entity using the information indicated by the control message included in the repetition of the first CORESET.

By using the first CORESET and at least one repetition of the first CORESET, the UE 115 may more reliably receive the information in the CORESET, which may increase a probability of successfully receiving the message (e.g., PDSCH or SIB1). For instance, a message (e.g., SIB1) may be more likely to be scheduled successfully by providing more opportunities to receive the first CORESET or by enabling combined decoding of the first CORESET and the repetition(s). This may improve the probability of receiving the message via one transmission, rather than via multiple transmissions of the message. Because the first CORESET itself is repeated in the monitoring occasion, this may also reduce or avoid repeatedly receiving pairs of a PDCCH and a PDSCH to successfully receive the message. Accordingly, latency for successful reception of a message may also be reduced. In some cases, the message may include a SIB1, which may be utilized to schedule further signaling or may allow a UE 115 to establish a link or connection. Accordingly, improving the reliability of CORESET reception via repetition of the CORESET may also improve subsequent signaling reliability or reduce latency for subsequent signaling.

By locating the repetition(s) of the CORESET in a predefined time or a predefined frequency relative to the first CORESET may reduce overhead signaling. For instance, a UE 115 may be enabled to locate one or more repetitions of the first CORESET with the predefined time or predefined frequency relationship between the first CORESET and the repetition(s), which may avoid overhead signaling to indicate the location of the repetition(s) in time or frequency. Additionally, or alternatively, the UE may be enabled to receive an SIB1 indicating the time and frequency relative to the first CORESET.

In some approaches, a message may include a SIB1 in a PDSCH. The SIB1 may indicate a repetition of a CORESET that is specific to a type of one or more search spaces. For example, the SIB1 may be utilized to indicate a repetition of another CORESET for a type of SIB that may be utilized to establish or improve a link. In some aspects, the SIB1 may indicate a repetition of a CORESET for a SIB19, where the SIB19 may be utilized to obtain significant data relating to an NTN node, such as an ephemeris. In some examples, Doppler information may be derived from the ephemeris and UE location. Utilizing the SIB1 to indicate repetition of a CORESET that is specific to a type of SIB may avoid performing repetitions for any or all CORESET types, thereby improving system efficiency and reducing UE complexity. For instance, a network may avoid transmitting some CORESET repetitions or a UE may avoid receiving some CORESET repetitions.

In some approaches, DCI in a CORESET may be utilized to indicate a quantity of slots for aggregation of a PDSCH that carries a SIB. The PDSCH may be carried in a CSS. Utilizing the DCI to indicate the quantity of slots for aggregation may allow flexibility in allocating resources for repetition of a PDSCH. Repeating the PDSCH that carries a SIB may provide an increased probability of reception of the PDSCH and the SIB. Because the SIB may be utilized for further scheduling or to establish a link, allowing an indication for repetition of the PDSCH carrying a SIB message may provide increased communication reliability.

In some approaches, a UE 115 may receive an SSB, where search space monitoring may be based on the monitoring occasion occurring within a threshold period after the SSB. The SSB may provide information that is utilized to receive signaling (e.g., a PDCCH) in the monitoring occasion. As a period between the SSB and signaling increases, the information of the SSB may be less relevant or accurate for receiving the signaling due to changes in the channel over time. Accordingly, keeping allowed monitoring occasions within the threshold period may increase the likelihood of receiving signaling in the monitoring occasions based on the SSB, as the information of the SSB may be more relevant or accurate.

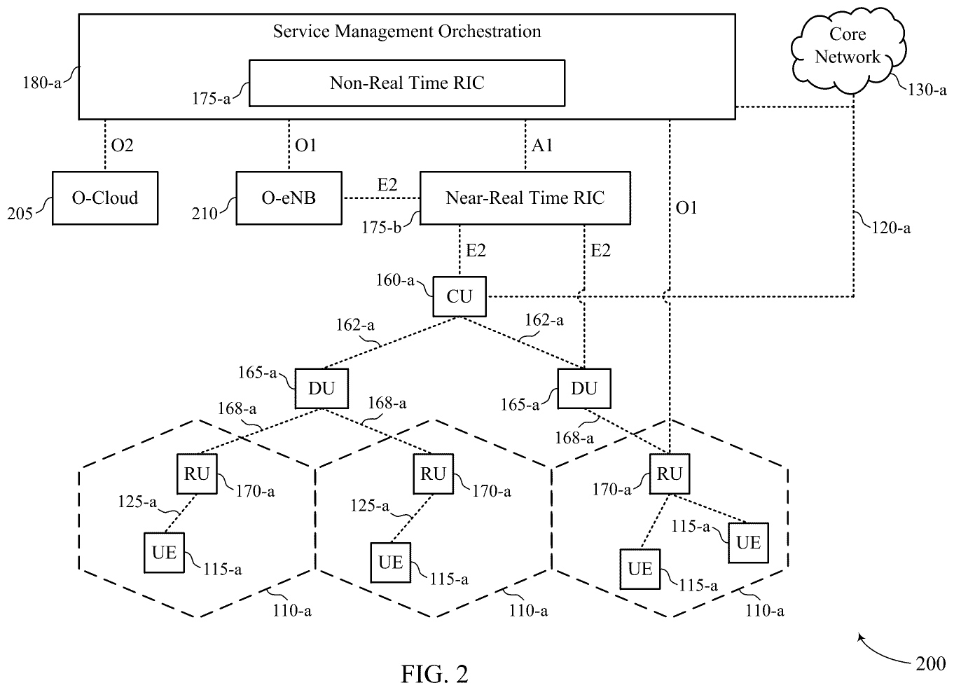

FIG. 2 shows an example of a network architecture 200 (e.g., a disaggregated base station architecture, a disaggregated RAN architecture) that supports signaling for system information blocks in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

Some examples of the techniques described herein may be implemented or performed by a UE 115-a or by an RU 170-a, DU 165-a, or CU 160-a. For example, an RU 170-a may transmit one or more CORESET repetitions. A UE 115-a may perform search space monitoring or may receive one or more CORESET repetitions. In some approaches, an RU 170-a or a UE 115-a may support slot aggregation for one or more PDSCHs carrying SIBs (for one or more PDSCHs scheduled using a CSS, for instance). In some approaches, one or more PDCCH monitoring occasions (for a SIB1 or SIB19, for instance) may be limited to a threshold period relative to (e.g., after) an SSB.

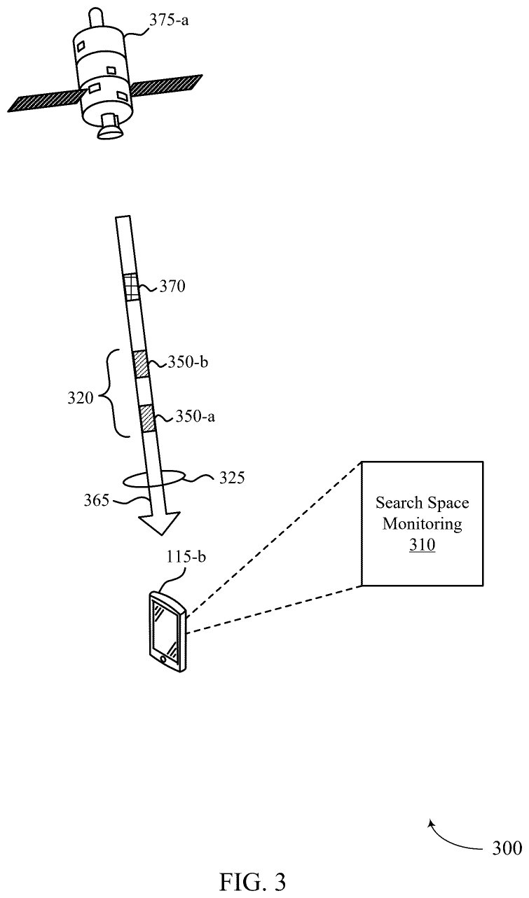

FIG. 3 shows an example of a wireless communications system 300 that supports signaling for system information blocks in accordance with one or more aspects of the present disclosure. In some examples, the wireless communications system 300 may implement aspects of the wireless communications system 100 or the network architecture 200. The wireless communications system 300 may include a UE 115-b and a network entity 375-a. With reference to FIG. 1, the UE 115-b may be an example of the UE 115 or the UE 115-a, the network entity 375-a may be an example of the CU 160-a, DU 165-a, or RU 170-a, or a combination thereof.

In some examples, the network entity 375-a may be a high altitude platform station (HAPS), high altitude vehicle (HAV), LEO satellite, or balloon, among other examples. For instance, the network entity 375-a may be in an orbit, such as low earth orbit, medium earth orbit, geostationary earth orbit, or other non-geostationary earth orbit. The network entity 375-a may be positioned at some distance from Earth (e.g., hundreds or thousands of kilometers from Earth), which may vary or remain relatively fixed. The network entity 375-a may include communication circuitry (e.g., one or more processors, memories, modems, baseband circuitries, among other examples), one or more antennas, or one or more transponders to facilitate reception and transmission of RF signals. The network entity 375-a may serve a geographic region for an NTN.

In some examples, the wireless communications system 300 may include one or more other NTN nodes or one or more TN nodes (not shown in FIG. 3). For instance, the UE 115-b may communicate with one or more NTN nodes or one or more TN nodes. In some examples, a TN node may be positioned on the Earth's surface or relatively near to the Earth's surface (e.g., within a mile or less from the Earth's surface). In some examples, a TN node may be anchored or attached to the Earth's surface. A TN node may include communication circuitry (e.g., one or more processors, memories, modems, baseband circuitries, among other examples) or one or more antennas to facilitate reception and transmission of RF signals. In some examples, a TN node may provide communication service within a cell area. In some cases, the cell area may be included within a geographic region served by the network entity 375-a, may partially overlap with the geographic region, or may be located outside of the geographic region. In some aspects, the network entity 375-a may be a TN node.

In some examples, network (e.g., RAN) functionality may be split between the network entity 375-a (e.g., a satellite, an RU on a satellite, or a gNB DU of the RAN, among other examples) and a TN node (e.g., a DU located on the ground or gNB CU of the RAN, among other examples). For instance, the network entity 375-a may be a DU 165 (e.g., may implement DU 165 functionality) and the TN node may be a CU (e.g., may implement CU 160 functionality). In some examples, the NTN node and the TN node may be next generation radio access network (NG-RAN) nodes. In some examples, a CU 160 and a DU 165 may reside on the ground and may be associated with one or more terrestrial and non-terrestrial cells or RUs. In a NTN, one or more DUs 165 may be located on a satellite and a CU 160 may be located on the Earth's surface. In some examples, the network entity 375-a and a TN node may be included in a RAN (e.g., NG-RAN) portion of the wireless communications system 300. In some examples, a UE 115-b may be excluded from the RAN (e.g., NG-RAN) portion of the wireless communications system 300.

The UE 115-b may communicate with the network entity 375-a using a communication link 325. The communication link 325 between the UE 115-b and the network entity 375-a may be an example of the communication links 125 described with respect to FIG. 1.

The communication link 325 may be a unidirectional link for downlink communications or may include a bi-directional link that enables uplink or downlink communications. For example, the network entity 375-a may transmit one or more downlink signals on a downlink 365 (e.g., downlink channel(s), downlink resource(s)), such as downlink control signals or downlink data signals, to the UE 115-b using the communication link 325. In some cases, the UE 115-b may transmit one or more signals on an uplink (e.g., uplink channel(s), uplink resource(s), not shown in FIG. 3), such as uplink control signals or uplink data signals, to the network entity 375-a using the communication link 325.

In some examples, the network entity 375-a may change position relative to the UE 115-b. Additionally, or alternatively, the UE 115-b may change position relative to the network entity 375-a. For instance, relative motion between the network entity 375-a and the UE 115-b may occur due to an orbit of the network entity 375-a, due to movement of the Earth, due to motion of the UE 115-b, a combination thereof. The relative motion between the network entity 375-a and the UE 115-b may result in variations in Doppler effect(s) (e.g., carrier frequency shift), timing (e.g., round trip time (RTT), path loss, or location (e.g., ephemeris), which may impact signaling between the network entity 375-a and the UE 115-b.

The network entity 375-a may transmit, in a search space during a monitoring occasion, a plurality 320 of CORESETs. The plurality 320 of CORESETs may include a first CORESET 350-a and one or more repetitions 350-b of the first CORESET 350-a. The plurality 320 of CORESETs may include a quantity (e.g., N=2, 3, 4, or another quantity) of CORESETs, including the first CORESET 350-a and one or more repetitions 350-b of the first CORESET 350-a. For a PDCCH with CORESET repetition, each repetition 350-b of the first CORESET 350-a may be identical to the first CORESET 350-a while being communicated (e.g., transmitted or received) using different resources (e.g., REs) than those used to communicate the first CORESET 350-a. For example, a repetition 350-b of the first CORESET 350-a may include the same content (e.g., at least some of the same information, a repeated PDCCH) or may be transmitted with one or more of the same parameters or characteristics (e.g., a same quantity of REs or a same DMRS) as the first CORESET 350-a.

In some examples, a CORESET may be a resource block. For example, CORESET repetition, from a PDCCH perspective, may mean that a resource block that houses the PDCCH repeats. The resource block may be larger than the resource(s) occupied by the PDCCH. In some cases, the REs in the CORESET and the repetition(s) of the CORESET that are not occupied by the PDCCH may be empty or different between repetitions. In some aspects, CORESET repetition may be specific to a type of PDCCH. For a PDCCH that schedules a SIB1, for instance, CORESET A and CORESET B (a repetition of CORESET A) may be transmitted. Both CORESET A and CORESET B may include a PDCCH that schedules a SIB1. In some cases, a CORESET (e.g., CORESET A) may include another PDCCH that will not be included in a repetition of the CORESET (e.g., CORESET B).

A search space may be a set of resources (e.g., time and frequency resources or REs, among other examples) within a CORESET that may be monitored (by the UE 115-b, for example) to detect a specific PDCCH. A monitoring occasion is a period in which a UE (e.g., the UE 115-b) may monitor for a PDCCH.

The UE 115-b may perform search space monitoring 310. For example, the UE 115-b may monitor a search space in the monitoring occasion for the plurality 320 of CORESETs, where the plurality 320 of CORESETs may include the first CORESET 350-a and one or more repetitions 350-b of the first CORESET 350-a. In some approaches, the UE 115-b may monitor the search space by attempting to receive and decode a PDCCH in the search space corresponding to the first CORESET 350-a or the repetition(s) 350-b of the first CORESET 350-a.

The UE 115-b may receive, from the network entity 375-a, the repetition 350-b of the first CORESET 350-a in the monitoring occasion via second REs. For instance, the UE 115-b may successfully receive and decode a PDCCH from the repetition 350-b of the first CORESET 350-a from the search space during the monitoring occasion. In some examples, the second REs may be located in a predefined time and a predefined frequency relative to first REs associated with the first CORESET 350-a. For instance, the second REs may be located at a time offset or a frequency offset relative to one or more of the first REs. As used herein, the term “predefined” in the context of the predefined time or predefined frequency may mean that the time or frequency may be established prior to transmission of a CORESET (e.g., a repeated CORESET). For instance, a predefined time or predefined frequency may be configured via signaling (e.g., signaling from the network entity 375-a, such as an SIB1) before a CORESET or a repetition thereof is transmitted or may be stored by the network entity 375-a or the UE 115-b at a manufacturing stage or an instruction update stage. In some aspects, the network entity 375-a may transmit CORESET repetition information (e.g., information indicating a quantity of repetitions, the predefined time, the predefined frequency, or mapping, among other examples) to the UE 115-b. In some approaches, the network entity 375-a or the UE 115-b may store the time or frequency relationship (e.g., predefined time, predefined frequency, time offset, frequency offset, or a mapping relationship from one or more of the first REs to the second REs, among other examples) to determine the location of the second REs relative to the location of the first REs. For example, the UE 115-b may determine a location of an RE of the second REs (e.g., a starting RE of the CORESET repetition or a starting RE of a PDCCH) based on the location of an RE of the first REs (e.g., a starting RE of the first CORESET or a starting RE of a PDCCH in the first CORESET) using the predefined time or predefined frequency (e.g., a time offset in an RE grid or a frequency offset in an RE grid).

In some aspects, the repetition 350-b of the first CORESET 350-a may include a control message scheduling transmission of a message 370. For example, the first CORESET 350-a or each repetition 350-b of the first CORESET may include a DCI message, a control message in a PDCCH, or other control information that indicates a schedule for the transmission of a message 370. In some examples, the message 370 may include a PDSCH or a SIB (e.g., SIB1) scheduled by the control message of the first CORESET 350-a or of the repetition(s) 350-b of the first CORESET 350-a.

The UE 115-b may communicate the message 370 with the network entity 375-a using information indicated by the control message included in the repetition 350-b of the first CORESET 350-a. For instance, the network entity 375-a may transmit, or the UE 115-b may receive, the message 370 using information (e.g., an indication of a time, slot, resource(s), RE(s), among other examples) indicated by the control message in the repetition 350-b. In some examples, the message 370 may be, or may include, a PDSCH or a SIB (e.g., SIB1). The network entity 375-a may transmit, or the UE 115-b may receive, the message 370 by transmitting or receiving the message 370 in accordance with the information (e.g., indication of a time, slot, resource(s), RE(s), among other examples).

In some examples, the message 370 may include a SIB1 in a PDSCH that is scheduled based at least in part on the plurality 320 of CORESETs (e.g., based on the first CORESET 350-a or the repetition 350-b of the first CORESET 350-a). The SIB1 may indicate a repetition of CORESET that is specific to a type of one or more search spaces (e.g., a search space such as Type 0 CSS, a UE-specific search space (USS), one or more types of one or more search spaces, or all search spaces, among other examples). For instance, the SIB1 may include information about CORESET repetition (e.g., a quantity of repetitions of a CORESET(s), or location of subsequent CORESET(s) relative to the first CORESET, or information for concurrent or subsequent transmission, among other examples) that is specific to a type of search space (e.g., Type0 CSS or a USS). In some aspects, the search space may be a search space that may carry a scheduling message of a SIB19. In some examples, the SIB1 that indicates a repetition of a second CORESET that is specific to a search space or type of search space may allow indication of the repetition of the CORESET without enabling repetition of all CORESET types. In some aspects, the SIB1 that indicates a repetition of a second CORESET that is specific to a search space or a type of search space may allow the UE 115-b to perform PDCCH decoding with CORESET repetition for a specific search space. The network entity 375-a may transmit, or the UE 115-b may receive, the repetition of the CORESET (e.g., CORESET content) based at least in part on the SIB1. For instance, the network entity 375-a may transmit, or the UE 115-b may receive, the CORESET or one or more repetitions of the CORESET. The repetition of the CORESET may increase a probability of successfully receiving the CORESET, which in turn may increase a probability of successfully receiving the type of SIB (e.g., SIB19) corresponding to the CORESET.

One or more approaches may be utilized to determine or indicate whether the repetition 350-b of the first CORESET 350-a is communicated or will be communicated. In some approaches, the UE 115-b may detect a failure to decode the first CORESET 350-a via the first REs associated with the first CORESET 350-a. The UE 115-b may monitor, during the monitoring occasion, for the repetition 350-b of the first CORESET 350-a via the second REs based on an assumption that CORESET repetition is activated in response to the failure to decode the first CORESET 350-a (e.g., the failure to decode a PDCCH in the first CORESET 350-a). In some examples, the monitoring for the repetition 350-b of the first CORESET 350-a may use blind decoding without a previous indication that CORESET repetition is activated. For instance, the UE 115-b may blindly decode a PDDCH using the repetition 350-b of the first CORESET 350-a in a case where the UE 115-b fails to decode using the first CORESET 350-a. Using the assumption or blind decoding in the case of a failure may allow repetition reception or decoding without an indication of activated CORESET repetition, which may reduce overhead signaling to indicate CORESET repetition.

In some aspects, the UE 115-b may decode a PDCCH using a combination of the first CORESET 350-a and the repetition 350-b of the first CORESET 350-a. For example, the UE 115-b may combine the first CORESET 350-a and the repetition 350-b of the first CORESET 350-a to obtain the PDCCH included in the CORESET more reliably. In some examples, the UE 115-b may perform soft combining of the first CORESET 350-a and the repetition 350-b of the first CORESET 350-a to decode the PDCCH.

In some approaches, the repetition 350-b of the first CORESET 350-a may be indicated by CRC masking, DMRS scrambling, or encoded DCI bit scrambling. For instance, the network entity 375-a may output (e.g., transmit), or the UE 115-b may receive the first CORESET 350-a with CRC masking, DMRS scrambling, or encoded DCI bit scrambling. In some aspects, a different CRC, DMRS masking, or scrambling bits may be used to indicate the repetition 350-b. Using CRC masking, DMRS scrambling, or DCI bits scrambling may provide a way to indicate the repetition 350-b using limited resources.

In some examples, the repetition 350-b of the first CORESET 350-a may be indicated by a quantity of the first REs associated with the first CORESET 350-a that satisfies a first threshold. For instance, in a case that a quantity (e.g., total quantity) of first REs associated with the first CORESET 350-a is less than the first threshold (e.g., 3 symbols or another amount of symbols), the UE 115-b may determine that CORESET repetition may be activated. For instance, the UE 115-b may detect CORESET repetition without a separate or explicit indication from the network (e.g., in a SIB1). For example, the UE may perform blind decoding based on an assumption that CORESET repetition is activated if the first threshold is satisfied. Additionally, or alternatively, in a case that the quantity of first REs associated with the first CORESET 350-a is less than the first threshold, the network entity 375-a may transmit, or the UE 115-b may receive, the repetition 350-b of the first CORESET 350-a. As used herein, “satisfying a threshold” may, depending on the context, refer to a value being greater than the threshold, greater than or equal to the threshold, less than the threshold, less than or equal to the threshold, equal to the threshold, not equal to the threshold, or the like.

In some examples, the repetition 350-b of the first CORESET 350-a may be indicated by a bandwidth or quantity of REs associated with the first CORESET 350-a that satisfies a second threshold. For instance, in a case that a bandwidth or a quantity of REs (e.g., a quantity of REs in a frequency dimension) associated with the first CORESET 350-a is less than the second threshold (e.g., 10 MHz, 5 MHz, or another bandwidth or amount of REs), the UE 115-b may determine that CORESET repetition may be activated. Additionally, or alternatively, in a case that the bandwidth or the quantity of REs associated with the first CORESET 350-a is less than the second threshold, the network entity 375-a may transmit, or the UE 115-b may receive, the repetition 350-b of the first CORESET 350-a.

In some examples, the repetition 350-b of the first CORESET 350-a may be indicated by communication of the first CORESET 350-a in a specific frequency band. For instance, in a case that the first CORESET 350-a is transmitted or received in a specific frequency band (e.g., a predefined or established frequency band), the network entity 375-a may indicate that CORESET repetition is activated or the UE 115-b may determine that CORESET repetition is activated. Additionally, or alternatively, in a case that the first CORESET 350-a is transmitted or received in a specific frequency band, the network entity 375-a may transmit, or the UE 115-b may receive, the repetition 350-b of the first CORESET 350-a. Using the quantity of first REs, the bandwidth or quantity of REs, or the frequency band to indicate CORESET repetition may provide a way to indicate the repetition 350-b using limited resources.

In some approaches, the network entity 375-a may transmit, or the UE 115-b may receive, a handover command for a target cell indicating the activated CORESET repetitions (e.g., a CORESET repetition configuration for a SIB1 or a CORESET repetition configuration for Type 0 CSS, among other examples) for the target cell. The network entity 375-a may transmit, or the UE 115-b may receive, neighbor cell information associated with a neighbor cell of the target cell. The neighbor cell information may indicate CORESET repetition information (e.g., a quantity of repetitions for the CORESET or a relationship between a CORESET and a repetition of the CORESET, among other examples) for the neighbor cell.

In some aspects, a PDCCH that schedules a SIB may be enhanced. For instance, one or more bits of a PDCCH associated with the first CORESET 350-a may be fixed or removed for a format of the PDCCH that is scrambled by a SI-RNTI in a specific frequency band. For example, some or all of the reserved bits for PDCCH format 1_0 scrambled by SI-RNTI in a specific frequency band may be removed or the values of some or all of the bits may be fixed. Removing some or all of the reserved bits or fixing some or all of the values of the reserved bits may improve decoding performance for the PDCCH.

In some examples, a PDSCH carrying one or more SIBs may be enhanced. DCI associated with the first CORESET 350-a may indicate a quantity of slots for aggregation of a PDSCH that carries a SIB. For instance, the network entity 375-a or the UE 115-b may support slot aggregation for one or more PDSCHs carrying one or more SIBs. The quantity of slots aggregated may be indicated in the DCI (e.g., using one or more reserved bits). In some approaches, one or more PDSCHs (e.g., one or more enhanced PDSCHs) may be scheduled using a CSS (e.g., the first CORESET 350-a or the repetition of the first CORESET 350-a that include the DCI may be communicated in the CSS).

In some examples, the network entity 375-a may transmit, or the UE 115-b may receive, an SSB (before the first CORESET 350-a, for instance). The search space may be monitored based on the monitoring occasion occurring within a threshold period after the SSB. In some aspects, the UE 115-b may not monitor the search space after the threshold period from a most recent SSB for the plurality 320 of CORESETs.

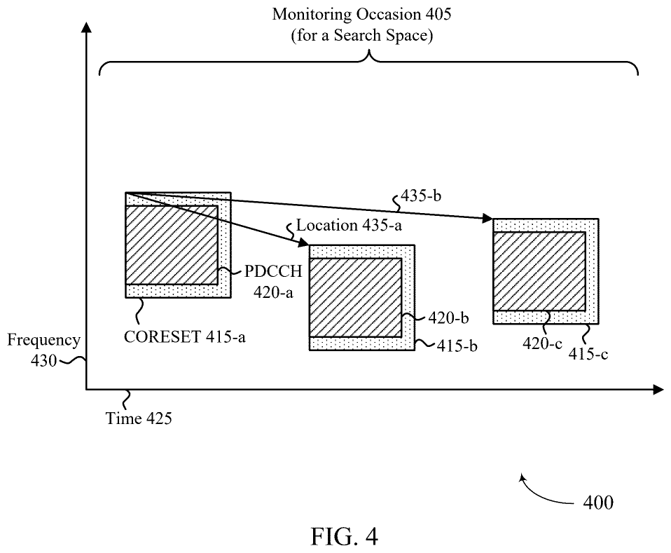

FIG. 4 shows an example of a timing diagram 400 that supports signaling for system information blocks in accordance with one or more aspects of the present disclosure. In some examples, one or more of the elements, structures, or operations described with reference to FIG. 4 may be utilized or performed by a UE (e.g., a UE 115, UE 115-a, or 115-b) or a network entity (e.g., network entity 105, CU 160-a, DU 165-a, RU 170-a, network entity 375-a) in accordance with one or more of the techniques described herein.

Examples of enhancements for a PDCCH that schedules one or more SIBs are shown in FIG. 4. The timing diagram 400 is illustrated in frequency 430 over time 425. In some examples, a search space is located in a monitoring occasion 405. Some approaches may utilize CORESET repetition or extension. In the example of FIG. 4, a plurality of CORESETs is illustrated, including a first CORESET 415-a, a second CORESET 415-b, and a third CORESET 415-c. The CORESET of a monitoring occasion 405 may be repeated N times, where N=3 in the example of FIG. 4. In other examples, other quantities (e.g., N=2, N=4, among other examples) for repetition may be utilized or specified. In some examples, the terms “repeat,” “repetition,” or variations thereof may refer to an initial element and one or more subsequent elements that match the initial element, or may refer to one or more elements that are subsequent to, and that match, an initial element.

In some examples, the frequency and time locations of repeated CORESET instances may be defined (e.g., predefined). For instance, a first location 435-a (e.g., RE or RE index) of the second CORESET 415-b may be at a predefined frequency and a predefined time relative to the first CORESET 415-a. A second location 435-b (e.g., an RE or RE index) of the third CORESET 415-c may be at a predefined frequency and a predefined time relative to the first CORESET 415-a. For instance, an RE of the second CORESET 415-b may be located at a predefined frequency offset or a predefined time offset (e.g., RE index offset) from the first CORESET 415-a, or an RE of the third CORESET 415-c may be located at a predefined frequency offset or a predefined time offset (e.g., RE index offset) from the first CORESET 415-a. In some examples, a CORESET may be located relative to an immediately preceding CORESET. For instance, the third CORESET 415-c may be located at a predefined frequency and a predefined time relative to the second CORESET 415-b.

As illustrated in FIG. 4, the first CORESET 415-a may include a first PDCCH 420-a, the second CORESET 415-b may include a second PDCCH 420-b, and the third CORESET 415-c may include a third PDCCH 420-c. In some examples, a quantity of REs in a repeated CORESET or PDCCH may be the same as a quantity of REs in an original CORESET or PDCCH. For instance, the second CORESET 415-b and the third CORESET 415-c may have respective quantities of REs that are the same as a quantity of REs of the first CORESET 415-a. Additionally, or alternatively, the second PDCCH 420-b and the third PDCCH 420-c may have respective quantities of REs that are the same as a quantity of REs of the first PDCCH 420-a. Accordingly, a network entity may transmit, or a UE may receive, a same quantity of REs for each CORESET in a plurality of CORESETs, or for each PDCCH in a plurality of PDCCHs. For a bandwidth of 5 MHz or lower, the maximal aggregation level of a PDCCH may be 8 (e.g., a maximum of 3 symbols for a CORESET).

In some examples for a PDCCH, the set of REs in a repeated CORESET instance may be derived by the set of REs in the original CORESET (e.g., the same sets of REs in the two CORESETs may be used). For instance, a set of REs for the second PDCCH 420-b within the second CORESET 415-b may the same as the set of REs for the first PDCCH 420-a within the first CORESET 415-a. In some examples, different sets of REs may be utilized for PDCCHs between CORESETs. In some aspects, a relationship of the REs (e.g., same or different REs) for PDCCHs between CORESETS may be predefined.

In some examples, a network entity (e.g., network entity 105, CU 160-a, DU 165-a, RU 170-a, network entity 375-a) may transmit, or a UE (e.g., a UE 115, UE 115-a, or 115-b) may receive, one or more of the first CORESET 415-a, the second CORESET 415-b, or the third CORESET 415-c. For instance, a UE may monitor one or more search spaces during the monitoring occasion 405 to receive the first CORESET 415-a, the second CORESET 415-b, or the third CORESET 415-c by attempting to decode received signals (e.g., the first PDCCH 420-a, the second PDCCH 420-b, and the third PDCCH 420-c) in the REs corresponding to the first CORESET 415-a, the second CORESET 415-b, and the third CORESET 415-c. In some approaches, a location of the first CORESET 415-a may be indicated or configured by a previously received SSB (not shown in FIG. 4), or the UE may blindly decode one or more search spaces to determine the location of the first CORESET 415-a. Using the location of the first CORESET 415-a and the predefined first location 435-a, the UE may receive the second CORESET 415-b. Using the location of the first CORESET 415-a and the predefined second location 435-b, the UE may receive the third CORESET 415-c. The first CORESET 415-a, the second CORESET 415-b, or the third CORESET 415-c (e.g., the first PDCCH 420-a, the second PDCCH 420-b, or the third PDCCH 420-c) may be combined for decoding in some approaches.

In some approaches, if decoding the first CORESET 415-a fails, the UE may attempt to decode the second CORESET 415-b or the third CORESET 415-c, which may indicate whether CORESET repetition is activated. For instance, no signaling of the CORESET repetition or extension may be utilized for CORESET0 for a SIB1 (before the SIB1, for example). For CORESET0 for SIB1 scheduling, for example, a UE perform blind decoding for cases with or without CORESET repetition. In some approaches, the UE may first attempt to decode the first CORESET 415-a assuming no repetition. If decoding the first CORESET 415-a fails, the UE may then attempt to decode assuming CORESET repetition applied.

In some aspects, CORESET repetition may be indicated. For instance, CORESET repetition may be indicated by CRC masking, DMRS scrambling, or encoded DCI bit scrambling associated with the first CORESET 415-a as described with reference to FIG. 3. To allow a UE to differentiate if CORESET repetition is applied, for instance, different CRC masking (e.g., RNTI), different DMRS scrambling sequences, or different DCI scrambling may be applied if CORESET repetition is activated (e.g., applied). Additionally, or alternatively, a network entity may inform a UE of CORESET0 repetition in a SIB1 for one or more subsequent SIB1s.

Additionally, or alternatively, CORESET repetition may be indicated by a quantity of first REs associated with the first CORESET 415-a satisfying a first threshold, by a bandwidth or quantity of REs satisfying a second threshold, or by communicating the first CORESET 415-a in a frequency band associated with CORESET repetition. For instance, CORESET repetition may be supported in (e.g., may be limited to) one or more bands, may be supported when the CORESET size (e.g., quantity of REs) is less than a threshold, or may be supported when a bandwidth is less than a threshold.

Additionally, or alternatively, CORESET repetition may be indicated by a handover command. For instance, CORESET repetition information of a target cell for SIBs is included in a handover command. CORESET repetition information for SIBs (e.g., SIB19) of one or more neighbor cells may be included in neighbor cell information.

Utilizing one or more of the indications (to allow the UE to differentiate when repetition is activated) may help to avoid instances where a UE may fail to decode a PDCCH in an initial CORESET but may attempt to decode a subsequent PDCCH assuming CORESET repetition when no repetition is applied. Or, utilizing one or more of the indications may help to avoid instances where a UE may decode a PDCCH assuming no repetition when repetition is applied.

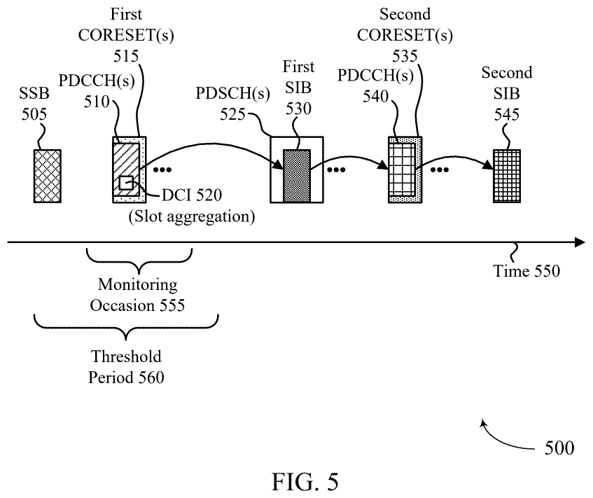

In some aspects, the first PDCCH 420-a, the second PDCCH 420-b, or the third PDCCH 420-c may include information (e.g., DCI) to schedule a subsequent PDSCH or SIB (e.g., SIB1). Examples of PDSCHs or SIBs that are scheduled by one or more CORESETs are given with reference to FIG. 3 and FIG. 5.

FIG. 5 shows an example of a timing diagram 500 that supports signaling for system information blocks in accordance with one or more aspects of the present disclosure. The timing diagram 500 is illustrated over time 550. In some examples, one or more of the elements, structures, or operations described with reference to FIG. 5 may be utilized or performed by a UE (e.g., a UE 115, UE 115-a, or 115-b) or a network entity (e.g., network entity 105, CU 160-a, DU 165-a, RU 170-a, network entity 375-a) in accordance with one or more of the techniques described herein.

Examples of enhancements for SIB (e.g., SIB1 or SIB19 for an NTN) transmissions are shown in FIG. 5. During initial access and before a UE acquires ephemeris information (e.g., by decoding a SIB19), the UE may lack information regarding Doppler effect(s) for a received downlink signal or may lack information regarding the timing variation due to feed link delay and satellite movement. For instance, Doppler effects or round trip time (RTT) may vary over time in an NTN. Due to the Doppler or timing variation, PDCCH or PDSCH reception performance may be degraded if the PDCCH or PDSCH is relatively distant from a received SSB in time (e.g., greater than 750 ms, 500 ms, 250 ms, 100 ms, or 50 ms, among other examples). SSB transmission periodicity may be increased to reduce the downlink overhead signaling.

In some examples, a network entity may transmit, or a UE may receive, an SSB 505. To address the Doppler or RTT variation after the SSB 505, a monitoring occasion 555 may be limited to occurring within a threshold period 560 after the SSB 505 (e.g., from the beginning or end of the SSB 505). For instance, PDCCH 510 monitoring occasions for a SIB1 or a SIB19 may be limited to being within a threshold period 560 after the transmitted SSB 505. In some aspects, a UE may not monitor a PDCCH monitoring occasion that is more than the threshold period 560 (e.g., X ms) after the most recent SSB 505 transmission. The threshold period 560 may be predefined, may depend on (e.g., may vary based on) subcarrier spacing (SCS), or may depend on (e.g., may vary based on) frequency range. In some aspects, one or more monitoring occasions may be defined for one or more SIBs (e.g., SIB1 or SIB19) based on SSB transmission times.

As illustrated in the example of FIG. 5, a monitoring occasion 555 occurs within the threshold period 560 after the SSB 505. One or more first CORESETs 515 may be received in the monitoring occasion 555. In some approaches, the one or more first CORESETs 515 may include an initial CORESET and one or more CORESET repetitions located in a predefined time or predefined frequency relative to the initial CORESET as described with reference to FIG. 3 or FIG. 4. For instance, one or more PDCCHs 510 may be received in the one or more first CORESETs 515.

In some aspects, a PDCCH 510 (e.g., one or more PDCCHs 510) that schedules a first SIB 530 may be enhanced. For instance, one or more bits of a PDCCH 510 associated with the first CORESET 515 may be fixed or removed for a format of the PDCCH that is scrambled by a SI-RNTI in a specific frequency band. For example, some or all of the reserved bits for PDCCH format 1_0 scrambled by SI-RNTI in a specific frequency band may be removed or the values of some or all of the bits may be fixed. Removing some or all of the reserved bits or fixing some or all of the values of the reserved bits may improve decoding performance for the PDCCH 510.

The PDCCH(s) 510 (e.g., DCI 520) may schedule one or more PDSCHs 525 or first SIBs 530 (e.g., SIB1 (s)). In some examples, DCI 520 associated with the first CORESET 515 (e.g., included in the PDCCH 510) may indicate a quantity of slots for aggregation of a PDSCH 525 (e.g., PDSCH repetition(s)) that carries the first SIB 530. For instance, the network entity 375-a or the UE 115-b may support slot aggregation for one or more PDSCHs 525 carrying one or more first SIBs 530. The quantity of slots aggregated may be indicated in the DCI 520 (e.g., using one or more reserved bits). In some approaches, one or more PDSCHs 525 may be scheduled using a CSS (e.g., one or more of the first CORESET(s) 515 that include the DCI 520 may be communicated in a CSS).

The first SIB 530 may indicate a repetition of a second CORESET 535 that is specific to a type of one or more search spaces. In some aspects, CORESET repetition or extension of one or more other SIBs of a serving cell may be signaled in the first SIB 530 (e.g., SIB1). For example, the first SIB 530 may indicate a quantity of repetitions or a repetition pattern for one or more other SIBs that may be specific to respective search space types or SIB types. In some aspects, a SIB1 may indicate that CORESET repetition is activated for one or more second CORESETs 535, where the second CORESET(s) 535 are specific to a type of search space. For instance, CORESET repetition may be applied specifically for a SIB19 (e.g., a SIB1 may use two CORESET repetitions and the SIB19 may use three CORESET repetitions). As illustrated in FIG. 5, the one or more second CORESETs 535 may include one or more respective PDCCHs 540. The second CORESET(s) 535 (e.g., the PDCCH(s)) may schedule the second SIB 545.

In some aspects, a repetition of a first CORESET may include a subset of contents of the first CORESET (e.g., and may not include a second subset of the contents of the first CORESET). As an illustrative example, the first CORESET may be used by a first search space for which PDCCH repetition is enabled and a second search space for which PDCCH repetition is not enabled. In such examples, the repetition of the first CORESET may include a repetition of a PDCCH associated with the first search space, and may not including a repetition of a PDCCH associated with the second search space. In some other examples (e.g., if repetition is enabled for each search space using the first CORESET), the repetition of the first CORESET may include the same contents as the first CORESET.

Some examples of the techniques described herein may be performed jointly or independently. In some approaches, monitoring occasion limitation or thresholding may be performed independently from one or more of the other techniques described herein. In some approaches, CORESET repetition may be performed independently from one or more of the other techniques described herein. In some approaches, slot aggregation (e.g., a DCI indicating slot aggregation for PDSCHs) may be performed independently from one or more of the other techniques described herein. In some approaches, indicating CORESET repetition that is specific to a type of SIB (e.g., SIB19) may be performed independently from one or more of the other techniques described herein.

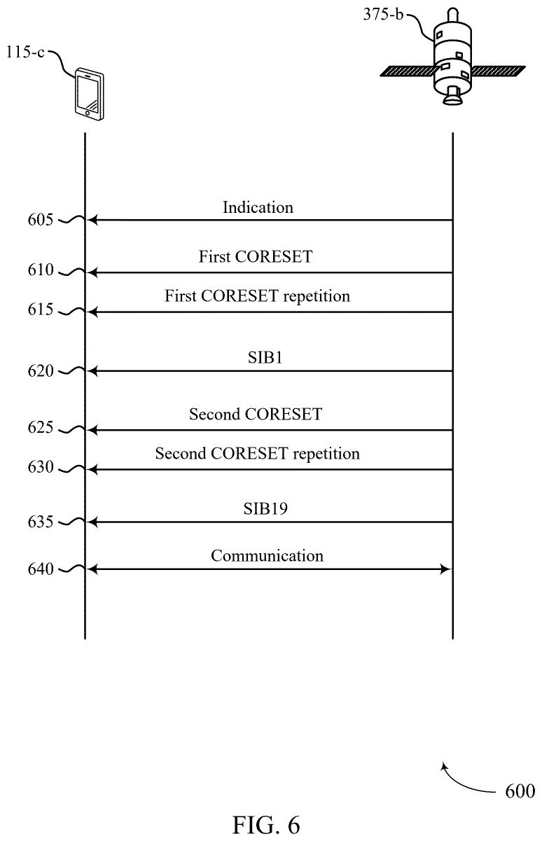

FIG. 6 shows an example of a process flow 600 that supports signaling for system information blocks in accordance with one or more aspects of the present disclosure. The process flow 600 may include a UE 115-c, which may be an example of UEs 115, 115-a, or 115-b, as described herein. The process flow 600 may also include a network entity 375-b, which may be an example of the network entity 375-a, as described herein (e.g., an NTN node, a TN node, or another network entity).

In the following description of the process flow 600, the communications between the UE 115-c and the network entity 375-b may be transmitted in a different order than the example order shown, or the operations performed by the UE 115-c or the network entity 375-b may be performed in different orders or at different times. Some operations may also be omitted from the process flow 600, or other operations may be added to the process flow 600. Further, although some operations or signaling may be shown to occur at different times for discussion purposes, these operations may actually occur at the same time or in overlapping time periods in some examples.

At 605, the network entity 375-b may transmit an indication to the UE 115-c. For instance, the indication may be transmitted to the UE 115-c to indicate that CORESET repetition is activated. In some examples, the indication 605 may include CRC masking, DMRS scrambling, or encoded DCI bit scrambling (of a first CORESET, for instance), or may be included in a handover command. Additionally, or alternatively, the indication may be provided by a quantity of REs satisfying a first threshold, by a bandwidth or quantity of REs satisfying a second threshold, or by communication of a first CORESET in a specific frequency band. Additional examples of indicating CORESET repetition are described with reference to one or more of FIGS. 3-5.

At 610, the network entity 375-b may transmit, or the UE 115-c may receive, a first CORESET. For instance, the UE 115-c may monitor a search space to receive the first CORESET as described with reference to one or more of FIGS. 3-5.

At 615, the network entity 375-b may transmit, or the UE 115-c may receive, a second CORESET. The second CORESET may be a repetition of the first CORESET (e.g., which may have a same candidate index and aggregation level as the first CORESET). For instance, the UE 115-c may receive the second CORESET at a time or a frequency that is defined relative to the first CORESET as described with reference to one or more of FIGS. 3-5. In some examples, the time and/or the frequency may be indicated via an SIB1. In some approaches, the time and/or the frequency may be expressed in terms of REs (e.g., RE offsets in time and frequency) from one or more first REs corresponding to the first CORESET. In some examples (e.g., for intra-slot repetition), the REs corresponding to the second CORESET may be within a same slot as the first REs corresponding to the first CORESET. In some examples (e.g., for inter-slot repetition), the REs corresponding to the second CORESET may be within a different slot from the first REs corresponding to the first CORESET.

The first CORESET or the second CORESET may include information (e.g., PDCCH(s), control message, or DCI) scheduling a SIB1. For example, the UE 115-c may decode the first CORESET and the second CORESET to determine the schedule (e.g., REs) for the SIB1 reception.

At 620, the network entity 375-b may transmit, or the UE 115-c may receive, the SIB1. For example, the UE 115-c may receive a message (e.g., PDSCH including the SIB1) scheduled by the first CORESET or the second CORESET as described with reference to one or more of FIG. 3 or FIG. 5. The SIB1 may indicate that CORESET repetition is activated for a SIB19. For instance, the SIB1 may include a bit, arrangement, code, or other information indicating that CORESET repetition is activated or configured for CORESET communication corresponding to a SIB19.

At 625, the network entity 375-b may transmit, or the UE 115-c may receive, an additional CORESET. For instance, the UE 115-c may monitor a search space to receive the additional CORESET as described with reference to one or more of FIG. 3 or FIG. 5.

At 630, the network entity 375-b may transmit, or the UE 115-c may receive, a third CORESET, which may be a repetition of the additional CORESET. For instance, the UE 115-c may receive the repetition of the additional CORESET at a time or a frequency that is defined relative to the additional CORESET as described with reference to one or more of FIGS. 3-5. In some approaches, the time or frequency may be expressed in terms of REs (e.g., RE offsets in time and frequency) from one or more second REs corresponding to the additional CORESET.

The additional CORESET or the repetition of the additional CORESET may include information (e.g., PDCCH(s), control message, or DCI) scheduling a SIB19. For example, the UE 115-c may decode the second CORESET and the repetition of the second CORESET to determine the schedule (e.g., REs) for the SIB19 reception.

At 635, the network entity 375-b may transmit, or the UE 115-c may receive, the SIB19. For example, the UE 115-c may receive a message (e.g., PDSCH including the SIB19) scheduled by the additional CORESET or the repetition of the additional CORESET as described with reference to one or more of FIG. 3 or FIG. 5. The SIB19 may include Doppler information, ephemeris information, or other information (e.g., timing information).

At 640, the network entity 375-b or the UE 115-c may communicate (e.g., transmit or receive one or more signals) based on the SIB19. For instance, the UE 115-c may utilize the Doppler information or the ephemeris information of the SIB 19 to perform filtering to compensate for Doppler shift in one or more signals received from the network entity 375-b. Additionally, or alternatively, the UE 115-c may utilize the ephemeris information to track the network entity 375-b, to perform power control, to perform inter-cell switching or handover, to perform transmit signal beamforming, or to perform receive signal beamforming, among other examples.

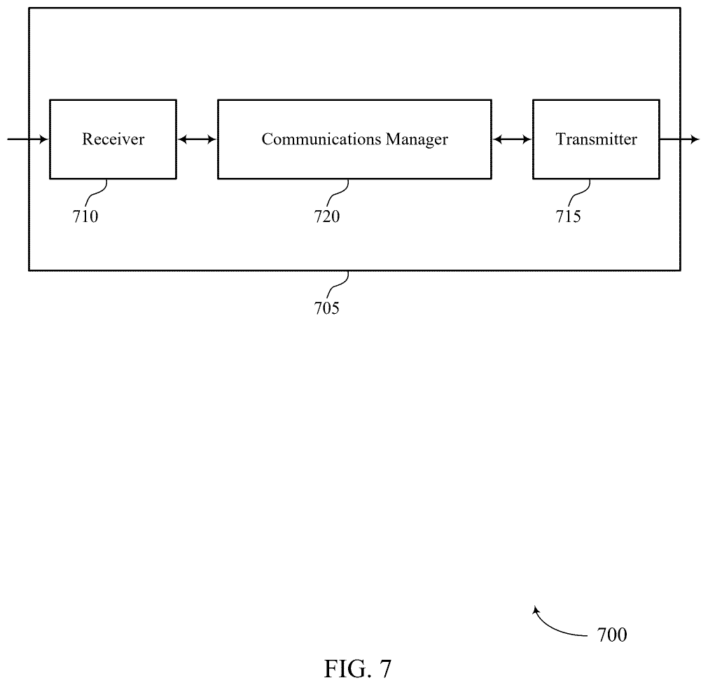

FIG. 7 shows a block diagram 700 of a device 705 that supports signaling for system information blocks in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to signaling for system information blocks). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to signaling for system information blocks). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of signaling for system information blocks as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for monitoring a search space in a monitoring occasion for a set of multiple CORESETs, the set of multiple CORESETs including a first CORESET and a second CORESET. The communications manager 720 is capable of, configured to, or operable to support a means for receiving, from a network entity, the second CORESET in the monitoring occasion via second REs that are located in a predefined time and a predefined frequency relative to first REs associated with the first CORESET, the second CORESET including a control message scheduling transmission of a message. The communications manager 720 is capable of, configured to, or operable to support a means for communicating the message with the network entity using information indicated by the control message included in the second CORESET.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, or more efficient utilization of communication resources.

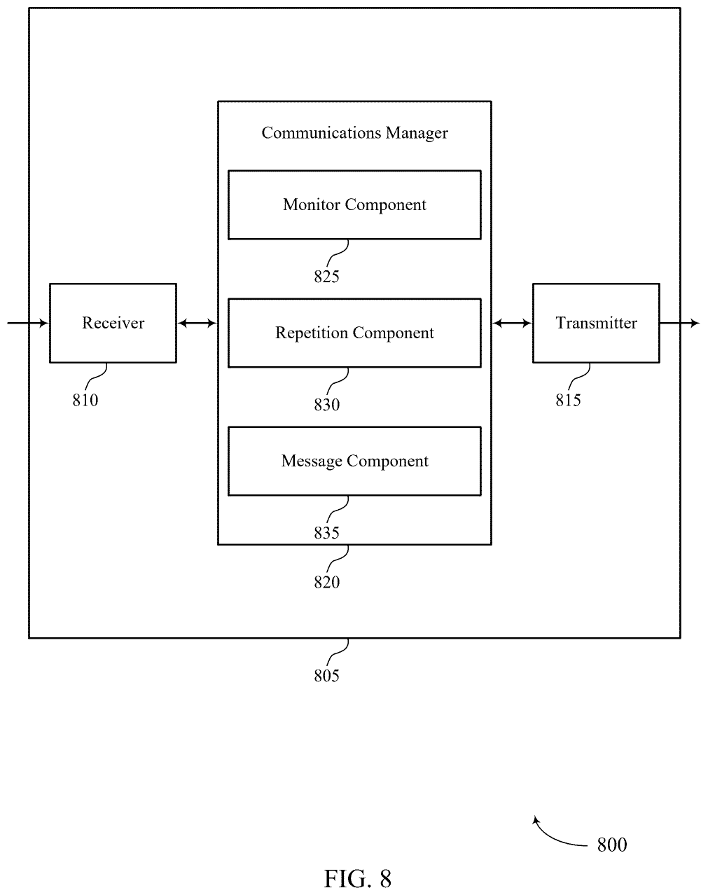

FIG. 8 shows a block diagram 800 of a device 805 that supports signaling for system information blocks in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to signaling for system information blocks). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to signaling for system information blocks). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of signaling for system information blocks as described herein. For example, the communications manager 820 may include a monitor component 825, a repetition component 830, a message component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The monitor component 825 is capable of, configured to, or operable to support a means for monitoring a search space in a monitoring occasion for a set of multiple CORESETs, the set of multiple CORESETs including a first CORESET and a second CORESET. The repetition component 830 is capable of, configured to, or operable to support a means for receiving, from a network entity, the second CORESET in the monitoring occasion via second REs that are located in a predefined time and a predefined frequency relative to first REs associated with the first CORESET, the second CORESET including a control message scheduling transmission of a message. The message component 835 is capable of, configured to, or operable to support a means for communicating the message with the network entity using information indicated by the control message included in the second CORESET.

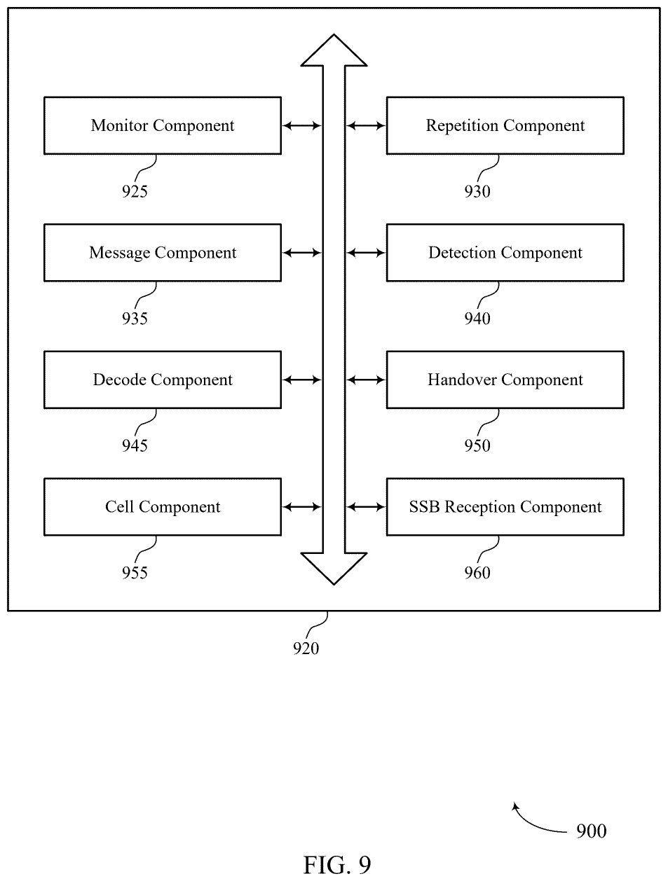

FIG. 9 shows a block diagram 900 of a communications manager 920 that supports signaling for system information blocks in accordance with one or more aspects of the present disclosure. The communications manager 920 may be an example of aspects of a communications manager 720, a communications manager 820, or both, as described herein. The communications manager 920, or various components thereof, may be an example of means for performing various aspects of signaling for system information blocks as described herein. For example, the communications manager 920 may include a monitor component 925, a repetition component 930, a message component 935, a detection component 940, a decode component 945, a handover component 950, a cell component 955, an SSB reception component 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The monitor component 925 is capable of, configured to, or operable to support a means for monitoring a search space in a monitoring occasion for a set of multiple CORESETs, the set of multiple CORESETs including a first CORESET and a second CORESET. The repetition component 930 is capable of, configured to, or operable to support a means for receiving, from a network entity, the second CORESET in the monitoring occasion via second REs that are located in a predefined time and a predefined frequency relative to first REs associated with the first CORESET, the second CORESET including a control message scheduling transmission of a message. The message component 935 is capable of, configured to, or operable to support a means for communicating the message with the network entity using information indicated by the control message included in the second CORESET.

In some examples, the message includes a SIB1 in an PDSCH that is scheduled based on the set of multiple CORESETs, and the SIB1 indicates a repetition of a CORESET that is specific to a type of one or more search spaces (e.g., one or more search space types).

In some examples, the repetition component 930 is capable of, configured to, or operable to support a means for receiving the repetition of the CORESET based on the SIB1.

In some examples, the detection component 940 is capable of, configured to, or operable to support a means for detecting a failure to decode the first CORESET via the first REs associated with the first CORESET. In some examples, the monitor component 925 is capable of, configured to, or operable to support a means for monitoring, during the monitoring occasion, for the second CORESET via the second REs based on an assumption that CORESET repetition is activated in response to the failure to decode the first CORESET.

In some examples, the monitoring for the second CORESET uses blind decoding without a previous indication that CORESET repetition is activated.

In some examples, the decode component 945 is capable of, configured to, or operable to support a means for decoding a PDCCH using a combination of the first CORESET and the second CORESET.

In some examples, the second CORESET is indicated by CRC masking, DMRS scrambling, or encoded DCI bit scrambling.

In some examples, the second CORESET is indicated by a quantity of the first REs associated with the first CORESET that satisfies a first threshold, by a bandwidth or quantity of REs associated with the first CORESET that satisfies a second threshold, or by communication of the first CORESET in a specific frequency band.

In some examples, the handover component 950 is capable of, configured to, or operable to support a means for receiving a handover command for a target cell indicating that CORESET repetition is activated. In some examples, the cell component 955 is capable of, configured to, or operable to support a means for receiving neighbor cell information associated with a neighbor cell of the target cell, the neighbor cell information indicating CORESET repetition information for the neighbor cell.

In some examples, one or more bits of a PDCCH associated with the first CORESET are fixed or removed for a format of the PDCCH that is scrambled by a SI-RNTI in a specific frequency band.

In some examples, DCI associated with the first CORESET indicates a quantity of slots for aggregation of an PDSCH that carries an SIB.

In some examples, the PDSCH is scheduled via a CSS.

In some examples, the SSB reception component 960 is capable of, configured to, or operable to support a means for receiving a synchronization signal block (SSB), where the search space is monitored based on the monitoring occasion occurring within a threshold period after the SSB.

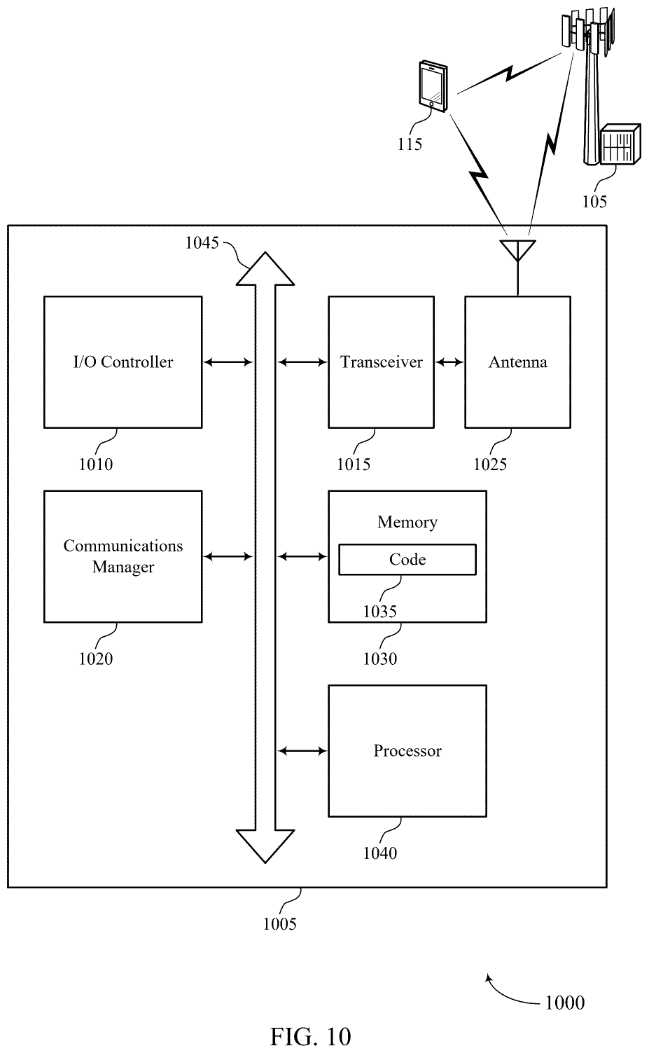

FIG. 10 shows a diagram of a system 1000 including a device 1005 that supports signaling for system information blocks in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting signaling for system information blocks). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for monitoring a search space in a monitoring occasion for a set of multiple CORESETs, the set of multiple CORESETs including a first CORESET and a second CORESET. The communications manager 1020 is capable of, configured to, or operable to support a means for receiving, from a network entity, the second CORESET in the monitoring occasion via second REs that are located in a predefined time and a predefined frequency relative to first REs associated with the first CORESET, the second CORESET including a control message scheduling transmission of a message. The communications manager 1020 is capable of, configured to, or operable to support a means for communicating the message with the network entity using information indicated by the control message included in the second CORESET.

By including or configuring the communications manager 1020 in accordance with examples as described herein, the device 1005 may support techniques for improved communication reliability, reduced latency, reduced power consumption, more efficient utilization of communication resources, improved coordination between devices, longer battery life, or improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of signaling for system information blocks as described herein, or the at least one processor 1040 and the at least one memory 1030 may be otherwise configured to, individually or collectively, perform or support such operations.

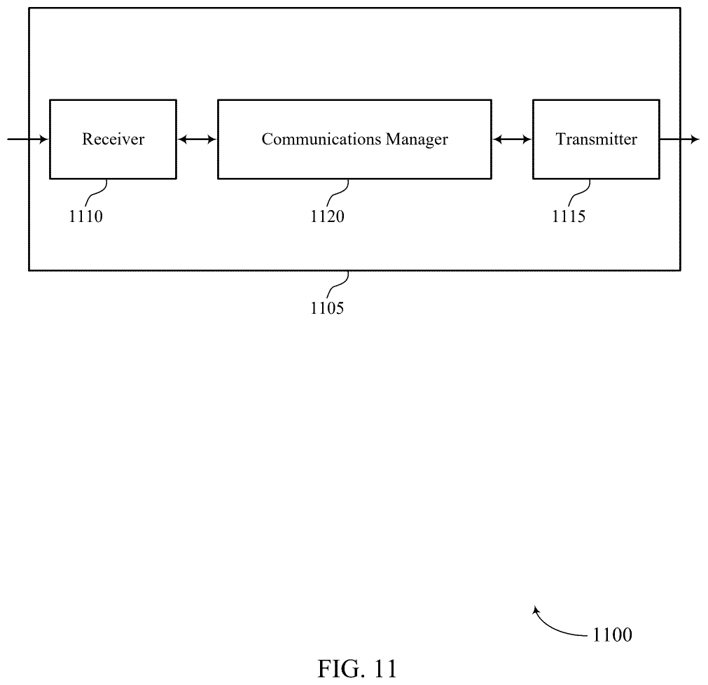

FIG. 11 shows a block diagram 1100 of a device 1105 that supports signaling for system information blocks in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of signaling for system information blocks as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting, in a search space during a monitoring occasion, a set of multiple CORESETs, the set of multiple CORESETs including a first CORESET and a second CORESET, where the second CORESET is transmitted via second REs that are located in a predefined time and a predefined frequency relative to first REs associated with the first CORESET, the second CORESET including a control message scheduling transmission of a message. The communications manager 1120 is capable of, configured to, or operable to support a means for communicating the message with a UE using information indicated by the control message included in the second CORESET.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, or more efficient utilization of communication resources.

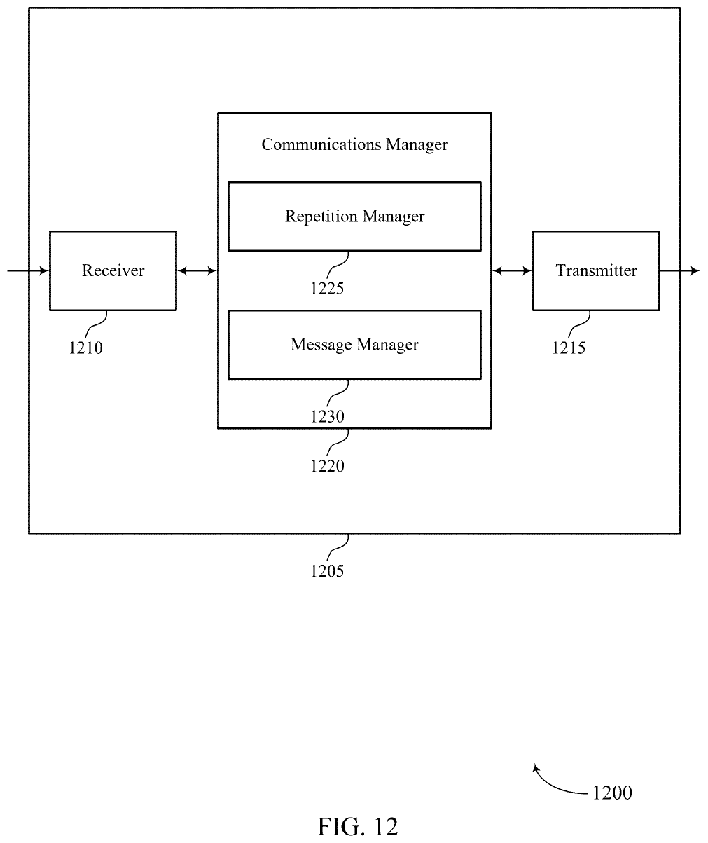

FIG. 12 shows a block diagram 1200 of a device 1205 that supports signaling for system information blocks in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of signaling for system information blocks as described herein. For example, the communications manager 1220 may include a repetition manager 1225 a message manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The repetition manager 1225 is capable of, configured to, or operable to support a means for transmitting, in a search space during a monitoring occasion, a set of multiple CORESETs, the set of multiple CORESETs including a first CORESET and a second CORESET, where the second CORESET is transmitted via second REs that are located in a predefined time and a predefined frequency relative to first REs associated with the first CORESET, the second CORESET including a control message scheduling transmission of a message. The message manager 1230 is capable of, configured to, or operable to support a means for communicating the message with a UE using information indicated by the control message included in the second CORESET.

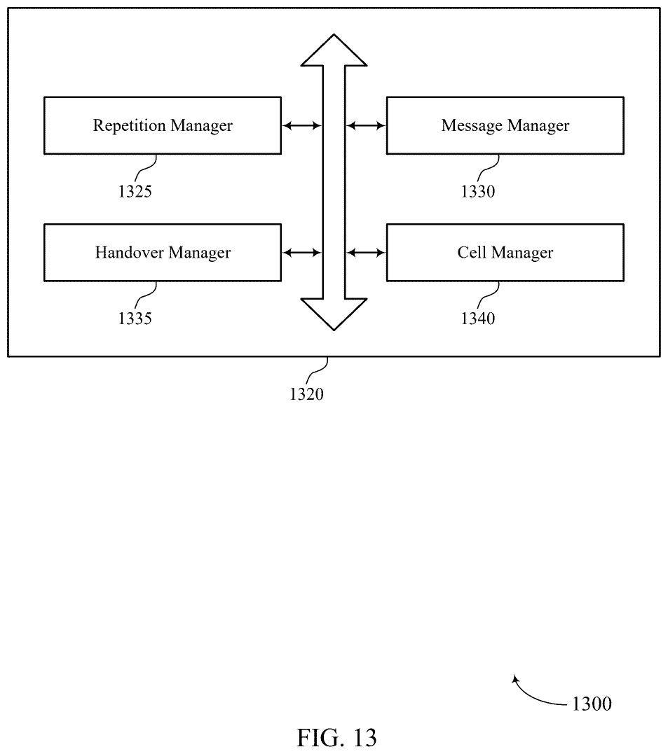

FIG. 13 shows a block diagram 1300 of a communications manager 1320 that supports signaling for system information blocks in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of signaling for system information blocks as described herein. For example, the communications manager 1320 may include a repetition manager 1325, a message manager 1330, a handover manager 1335, a cell manager 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The repetition manager 1325 is capable of, configured to, or operable to support a means for transmitting, in a search space during a monitoring occasion, a set of multiple CORESETs, the set of multiple CORESETs including a first CORESET and a second CORESET, where the second CORESET is transmitted via second REs that are located in a predefined time and a predefined frequency relative to first REs associated with the first CORESET, the second CORESET including a control message scheduling transmission of a message. The message manager 1330 is capable of, configured to, or operable to support a means for communicating the message with a UE using information indicated by the control message included in the second CORESET.

In some examples, the message includes a SIB1 in an PDSCH that is scheduled based on the set of multiple CORESETs, and the SIB1 indicates a repetition of a CORESET that is specific to a type of one or more search spaces.

In some examples, the repetition manager 1325 is capable of, configured to, or operable to support a means for transmitting the repetition of the CORESET based on the SIB1.

In some examples, the second CORESET is indicated by CRC masking, DMRS scrambling, or encoded DCI bit scrambling.

In some examples, the second CORESET is indicated by a quantity of the first REs associated with the first CORESET that satisfies a first threshold, by a bandwidth or quantity of REs associated with the first CORESET that satisfies a second threshold, or by communication of the first CORESET in a specific frequency band.

In some examples, the handover manager 1335 is capable of, configured to, or operable to support a means for transmitting a handover command for a target cell indicating that CORESET repetition is activated. In some examples, the cell manager 1340 is capable of, configured to, or operable to support a means for transmitting neighbor cell information associated with a neighbor cell of the target cell, the neighbor cell information indicating CORESET repetition information for the neighbor cell.

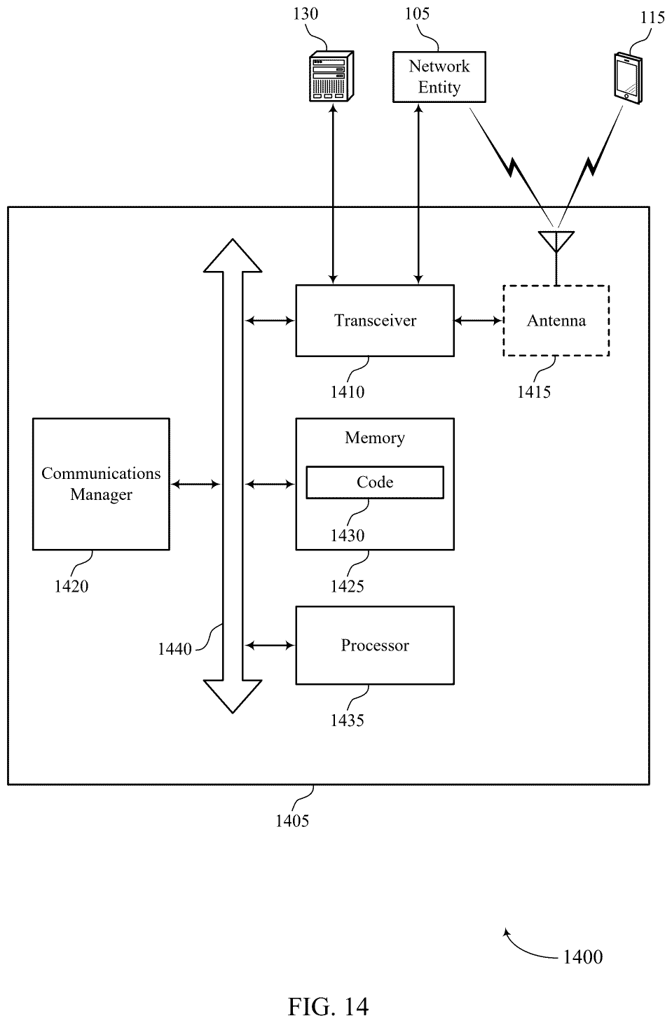

FIG. 14 shows a diagram of a system 1400 including a device 1405 that supports signaling for system information blocks in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting signaling for system information blocks). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting, in a search space during a monitoring occasion, a set of multiple CORESETs, the set of multiple CORESETs including a first CORESET and a second CORESET, where the second CORESET is transmitted via second REs that are located in a predefined time and a predefined frequency relative to first REs associated with the first CORESET, the second CORESET including a control message scheduling transmission of a message. The communications manager 1420 is capable of, configured to, or operable to support a means for communicating the message with a UE using information indicated by the control message included in the second CORESET.

By including or configuring the communications manager 1420 in accordance with examples as described herein, the device 1405 may support techniques for improved communication reliability, reduced latency, reduced power consumption, more efficient utilization of communication resources, improved coordination between devices, longer battery life, or improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of signaling for system information blocks as described herein, or the at least one processor 1435 and the at least one memory 1425 may be otherwise configured to, individually or collectively, perform or support such operations.

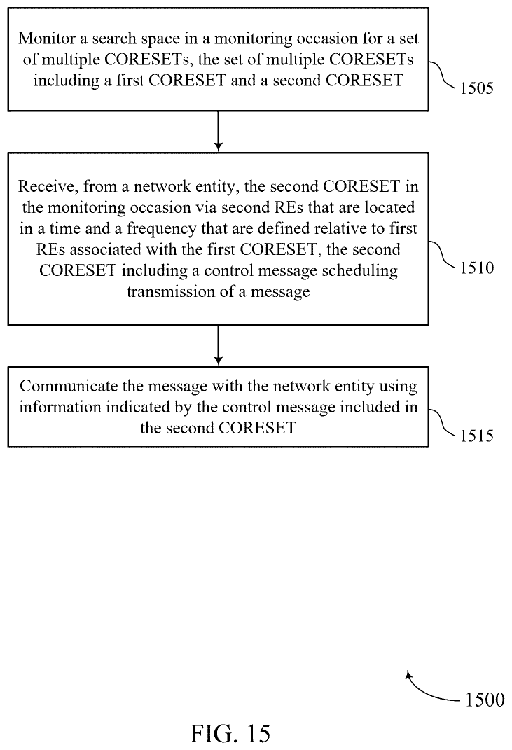

FIG. 15 shows a flowchart illustrating a method 1500 that supports signaling for system information blocks in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include monitoring a search space in a monitoring occasion for a set of multiple CORESETs, the set of multiple CORESETs including a first CORESET and a second CORESET. The operations of 1505 may be performed in accordance with examples as disclosed herein. In some examples, aspects of the operations of 1505 may be performed by a monitor component 925 as described with reference to FIG. 9.

At 1510, the method may include receiving, from a network entity, the second CORESET in the monitoring occasion via second REs that are located in a predefined time and a predefined frequency relative to first REs associated with the first CORESET, the second CORESET including a control message scheduling transmission of a message. The operations of 1510 may be performed in accordance with examples as disclosed herein. In some examples, aspects of the operations of 1510 may be performed by a repetition component 930 as described with reference to FIG. 9.

At 1515, the method may include communicating the message with the network entity using information indicated by the control message included in the second CORESET. The operations of 1515 may be performed in accordance with examples as disclosed herein. In some examples, aspects of the operations of 1515 may be performed by a message component 935 as described with reference to FIG. 9.

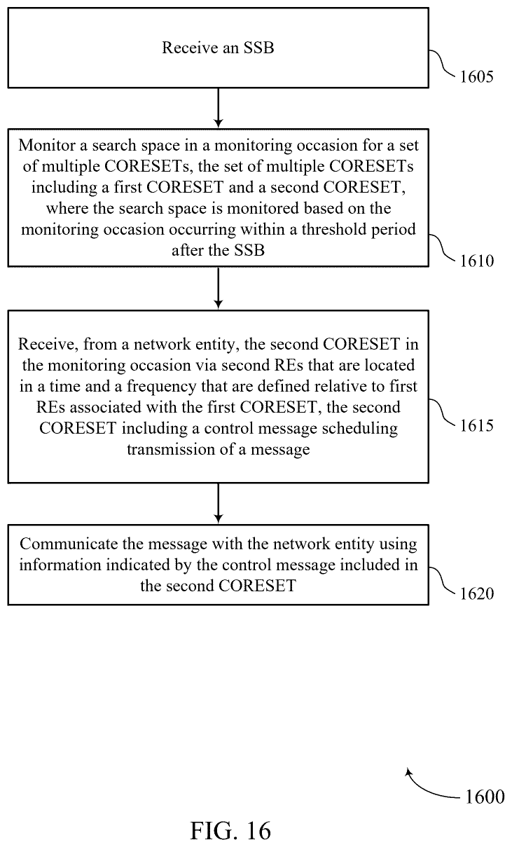

FIG. 16 shows a flowchart illustrating a method 1600 that supports signaling for system information blocks in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving an SSB. The operations of 1605 may be performed in accordance with examples as disclosed herein. In some examples, aspects of the operations of 1605 may be performed by an SSB reception component 960 as described with reference to FIG. 9.

At 1610, the method may include monitoring a search space in a monitoring occasion for a set of multiple CORESETs, the set of multiple CORESETs including a first CORESET and a second CORESET, where the search space is monitored based on the monitoring occasion occurring within a threshold period after the SSB. The operations of 1610 may be performed in accordance with examples as disclosed herein. In some examples, aspects of the operations of 1610 may be performed by a monitor component 925 as described with reference to FIG. 9.

At 1615, the method may include receiving, from a network entity, the second CORESET in the monitoring occasion via second REs that are located in a predefined time and a predefined frequency relative to first REs associated with the first CORESET, the second CORESET including a control message scheduling transmission of a message. The operations of 1615 may be performed in accordance with examples as disclosed herein. In some examples, aspects of the operations of 1615 may be performed by a repetition component 930 as described with reference to FIG. 9.

At 1620, the method may include communicating the message with the network entity using information indicated by the control message included in the second CORESET. The operations of 1620 may be performed in accordance with examples as disclosed herein. In some examples, aspects of the operations of 1620 may be performed by a message component 935 as described with reference to FIG. 9.

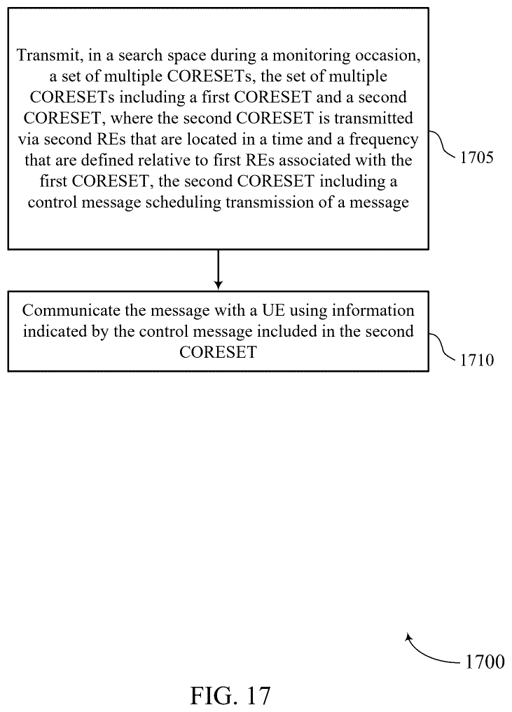

FIG. 17 shows a flowchart illustrating a method 1700 that supports signaling for system information blocks in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, in a search space during a monitoring occasion, a set of multiple CORESETs, the set of multiple CORESETs including a first CORESET and a second CORESET, where the second CORESET is transmitted via second REs that are located in a predefined time and a predefined frequency relative to first REs associated with the first CORESET, the second CORESET including a control message scheduling transmission of a message. The operations of 1705 may be performed in accordance with examples as disclosed herein. In some examples, aspects of the operations of 1705 may be performed by a repetition manager 1325 as described with reference to FIG. 13.

At 1710, the method may include communicating the message with a UE using information indicated by the control message included in the second CORESET. The operations of 1710 may be performed in accordance with examples as disclosed herein. In some examples, aspects of the operations of 1710 may be performed by a message manager 1330 as described with reference to FIG. 13.

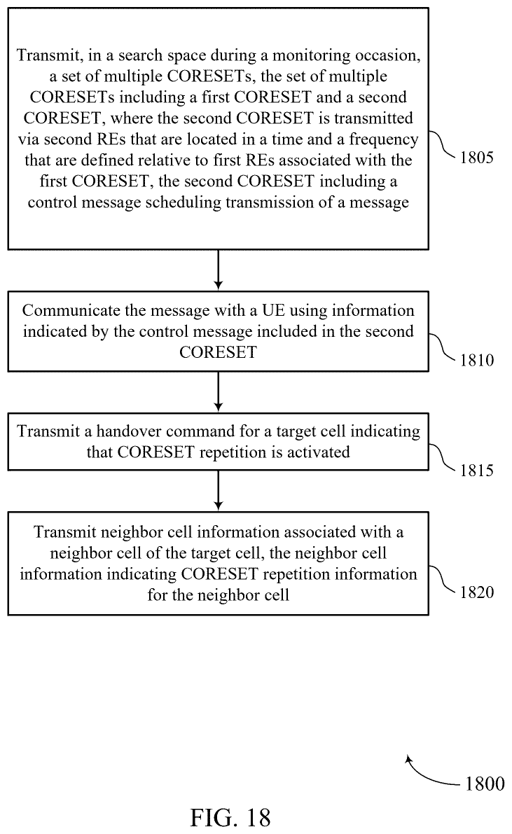

FIG. 18 shows a flowchart illustrating a method 1800 that supports signaling for system information blocks in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, in a search space during a monitoring occasion, a set of multiple CORESETs, the set of multiple CORESETs including a first CORESET and a second CORESET, where the second CORESET is transmitted via second REs that are located in a predefined time and a predefined frequency relative to first REs associated with the first CORESET, the second CORESET including a control message scheduling transmission of a message. The operations of 1805 may be performed in accordance with examples as disclosed herein. In some examples, aspects of the operations of 1805 may be performed by a repetition manager 1325 as described with reference to FIG. 13.

At 1810, the method may include communicating the message with a UE using information indicated by the control message included in the second CORESET. The operations of 1810 may be performed in accordance with examples as disclosed herein. In some examples, aspects of the operations of 1810 may be performed by a message manager 1330 as described with reference to FIG. 13.

At 1815, the method may include transmitting a handover command for a target cell indicating that CORESET repetition is activated. The operations of 1815 may be performed in accordance with examples as disclosed herein. In some examples, aspects of the operations of 1815 may be performed by a handover manager 1335 as described with reference to FIG. 13.

At 1820, the method may include transmitting neighbor cell information associated with a neighbor cell of the target cell, the neighbor cell information indicating CORESET repetition information for the neighbor cell. The operations of 1820 may be performed in accordance with examples as disclosed herein. In some examples, aspects of the operations of 1820 may be performed by a cell manager 1340 as described with reference to FIG. 13.

The following provides an overview of aspects of the present disclosure:

Aspect 1: A method for wireless communications by a UE, comprising: monitoring a search space in a monitoring occasion for a plurality of CORESETs, the plurality of CORESETs comprising a first CORESET and a second CORESET; receiving, from a network entity, the second CORESET in the monitoring occasion via second REs that are located in a predefined time and a predefined frequency relative to first REs associated with the first CORESET, the second CORESET comprising a control message scheduling transmission of a message; and communicating the message with the network entity using information indicated by the control message included in the second CORESET.

Aspect 2: The method of aspect 1, wherein the message comprises a SIB1 in a PDSCH that is scheduled based at least in part on the plurality of CORESETs, and the SIB1 indicates a repetition of a CORESET that is specific to a type of one or more search spaces.

Aspect 3: The method of aspect 2, further comprising: receiving the repetition of the CORESET based at least in part on the SIB1.

Aspect 4: The method of any of aspects 1 through 3, further comprising: detecting a failure to decode the first CORESET via the first REs associated with the first CORESET; and monitoring, during the monitoring occasion, for the second CORESET via the second REs based at least in part on an assumption that CORESET repetition is activated in response to the failure to decode the first CORESET.

Aspect 5: The method of aspect 4, wherein the monitoring for the second CORESET uses blind decoding without a previous indication that CORESET repetition is activated.

Aspect 6: The method of any of aspects 1 through 5, further comprising: decoding a PDCCH using a combination of the first CORESET and the second CORESET.

Aspect 7: The method of any of aspects 1 through 4, wherein the second CORESET is indicated by CRC masking, DMRS scrambling, or encoded DCI bit scrambling.

Aspect 8: The method of any of aspects 1 through 4 and 7, wherein the second CORESET is indicated by a quantity of the first REs associated with the first CORESET that satisfies a first threshold, by a bandwidth or quantity of REs associated with the first CORESET that satisfies a second threshold, or by communication of the first CORESET in a specific frequency band.

Aspect 9: The method of any of aspects 1 through 4 and 7 through 8, further comprising: receiving a handover command for a target cell indicating that CORESET repetition is activated; and receiving neighbor cell information associated with a neighbor cell of the target cell, the neighbor cell information indicating CORESET repetition information for the neighbor cell.

Aspect 10: The method of any of aspects 1 through 9, wherein one or more bits of a PDCCH associated with the first CORESET are fixed or removed for a format of the PDCCH that is scrambled by a SI-RNTI in a specific frequency band.

Aspect 11: The method of any of aspects 1 through 10, wherein DCI associated with the first CORESET indicates a quantity of slots for aggregation of an PDSCH that carries an SIB.

Aspect 12: The method of aspect 11, wherein the PDSCH is scheduled via a CSS.

Aspect 13: The method of any of aspects 1 through 12, further comprising: receiving an SSB, wherein the search space is monitored based at least in part on the monitoring occasion occurring within a threshold period after the SSB.

Aspect 14: A method for wireless communications by a network entity, comprising: transmitting, in a search space during a monitoring occasion, a plurality of CORESETs, the plurality of CORESETs comprising a first CORESET and a second CORESET, wherein the second CORESET is transmitted via second REs that are located in a predefined time and a predefined frequency relative to first REs associated with the first CORESET, the second CORESET comprising a control message scheduling transmission of a message; and communicating the message with a UE using information indicated by the control message included in the second CORESET.

Aspect 15: The method of aspect 14, wherein the message comprises a SIB1 in an PDSCH that is scheduled based at least in part on the plurality of CORESETs, and the SIB1 indicates a repetition of a CORESET that is specific to a type of one or more search spaces.

Aspect 16: The method of aspect 15, further comprising: transmitting the repetition of the CORESET based at least in part on the SIB1.

Aspect 17: The method of any of aspects 14 through 16, wherein the second CORESET is indicated by CRC masking, DMRS scrambling, or encoded DCI bit scrambling.

Aspect 18: The method of any of aspects 14 through 17, wherein the second CORESET is indicated by a quantity of the first REs associated with the first CORESET that satisfies a first threshold, by a bandwidth or quantity of REs associated with the first CORESET that satisfies a second threshold, or by communication of the first CORESET in a specific frequency band.

Aspect 19: The method of any of aspects 14 through 18, further comprising: transmitting a handover command for a target cell indicating that CORESET repetition is activated; and transmitting neighbor cell information associated with a neighbor cell of the target cell, the neighbor cell information indicating CORESET repetition information for the neighbor cell.

Aspect 20: A UE for wireless communications, comprising one or more memories storing processor-executable code, and one or more processors coupled with the one or more memories and individually or collectively operable to execute the code to cause the UE to perform a method of any of aspects 1 through 13.

Aspect 21: A UE for wireless communications, comprising at least one means for performing a method of any of aspects 1 through 13.

Aspect 22: A non-transitory computer-readable medium storing code for wireless communications, the code comprising instructions executable by one or more processors to perform a method of any of aspects 1 through 13.

Aspect 23: A network entity for wireless communications, comprising one or more memories storing processor-executable code, and one or more processors coupled with the one or more memories and individually or collectively operable to execute the code to cause the network entity to perform a method of any of aspects 14 through 19.

Aspect 24: A network entity for wireless communications, comprising at least one means for performing a method of any of aspects 14 through 19.

Aspect 25: A non-transitory computer-readable medium storing code for wireless communications, the code comprising instructions executable by one or more processors to perform a method of any of aspects 14 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
monitor a search space in a monitoring occasion for a plurality of control resource sets (CORESETs), the plurality of CORESETs comprising a first CORESET and a second CORESET;
receive, from a network entity, the second CORESET in the monitoring occasion via second resource elements (REs) that are located in a time and a frequency that are defined relative to first REs associated with the first CORESET, the second CORESET comprising a control message scheduling transmission of a message; and
communicate the message with the network entity using information indicated by the control message included in the second CORESET.

2. The UE of claim 1, wherein the message comprises a system information block 1 (SIB1) in a physical downlink shared channel (PDSCH) that is scheduled based at least in part on the plurality of CORESETs, and the SIB1 indicates a repetition of a CORESET that is specific to a type of one or more search spaces.

3. The UE of claim 2, wherein the one or more processors are individually or collectively further operable to execute the code to cause the UE to:
receive the second CORESET based at least in part on the SIB1.

4. The UE of claim 1, wherein the one or more processors are individually or collectively further operable to execute the code to cause the UE to:
receive a system information block 1 (SIB1), wherein the SIB1 indicates the time and the frequency that are defined relative to the first REs associated with the first CORESET.

5. The UE of claim 1, wherein the one or more processors are individually or collectively further operable to execute the code to cause the UE to:
detect a failure to decode the first CORESET via the first REs associated with the first CORESET; and
monitor, during the monitoring occasion, for the second CORESET via the second REs based at least in part on an assumption that CORESET repetition is activated in response to the failure to decode the first CORESET.

6. The UE of claim 5, wherein the monitoring for the second CORESET uses blind decoding without a previous indication that CORESET repetition is activated.

7. The UE of claim 1, wherein the one or more processors are individually or collectively further operable to execute the code to cause the UE to:
decode a physical downlink control channel (PDCCH) using a combination of the first CORESET and the second CORESET.

8. The UE of claim 1, wherein:
the second CORESET is indicated by cyclic redundancy check (CRC) masking, demodulation reference signal (DMRS) scrambling, or encoded downlink control information (DCI) bit scrambling.

9. The UE of claim 1, wherein the second CORESET is indicated by a quantity of the first REs associated with the first CORESET that satisfies a first threshold, by a bandwidth or quantity of REs associated with the first CORESET that satisfies a second threshold, or by communication of the first CORESET in a specific frequency band.

10. The UE of claim 1, wherein the one or more processors are individually or collectively further operable to execute the code to cause the UE to:
receive a handover command for a target cell indicating that CORESET repetition is activated; and
receive neighbor cell information associated with a neighbor cell of the target cell, the neighbor cell information indicating CORESET repetition information for the neighbor cell.

11. The UE of claim 1, wherein one or more bits of a physical downlink control channel (PDCCH) associated with the first CORESET are fixed or removed for a format of the PDCCH that is scrambled by a system information radio network temporary identifier (SI-RNTI) in a specific frequency band.

12. The UE of claim 1, wherein downlink control information (DCI) associated with the first CORESET indicates a quantity of slots for aggregation of a physical downlink shared channel (PDSCH) that carries a system information block (SIB).

13. The UE of claim 12, wherein the physical downlink shared channel (PDSCH) is scheduled via a common search space (CSS).

14. The UE of claim 1, wherein the one or more processors are individually or collectively further operable to execute the code to cause the UE to:
receive a synchronization signal block (SSB),
wherein the search space is monitored based at least in part on the monitoring occasion occurring within a threshold period after the SSB.

15. A network entity, comprising:
one or more memories storing processor-executable code; and
one or more processors coupled with the one or more memories and individually or collectively operable to execute the code to cause the network entity to:
transmit, in a search space during a monitoring occasion, a plurality of control resource sets (CORESETs), the plurality of CORESETs comprising a first CORESET and a second CORESET,
wherein the second CORESET is transmitted via second resource elements (REs) that are located in a time and a frequency that are defined relative to first REs associated with the first CORESET, the second CORESET comprising a control message scheduling transmission of a message; and
communicate the message with a user equipment (UE) using information indicated by the control message included in second CORESET.

16. The network entity of claim 15, wherein the message comprises a system information block 1 (SIB1) in a physical downlink shared channel (PDSCH) that is scheduled based at least in part on the plurality of CORESETs, and the SIB1 indicates a repetition of a CORESET that is specific to a type of one or more search spaces.

17. The network entity of claim 16, wherein the one or more processors are individually or collectively further operable to execute the code to cause the network entity to:
transmit the second CORESET based at least in part on the SIB1.

18. The network entity of claim 15, wherein:
the second CORESET is indicated by cyclic redundancy check (CRC) masking, demodulation reference signal (DMRS) scrambling, or encoded downlink control information (DCI) bit scrambling.

19. The network entity of claim 15, wherein the one or more processors are individually or collectively further operable to execute the code to cause the network entity to:
transmit a handover command for a target cell indicating that CORESET repetition is activated; and
transmit neighbor cell information associated with a neighbor cell of the target cell, the neighbor cell information indicating CORESET repetition information for the neighbor cell.

20. A method for wireless communications by a user equipment (UE), comprising:
monitoring a search space in a monitoring occasion for a plurality of control resource sets (CORESETs), the plurality of CORESETs comprising a first CORESET and a second CORESET;
receiving, from a network entity, the second CORESET in the monitoring occasion via second resource elements (REs) that are located in a time and a frequency that are defined relative to first REs associated with the first CORESET, the second CORESET comprising a control message scheduling transmission of a message; and
communicating the message with the network entity using information indicated by the control message included in the second CORESET.
